(19) United States
(12) Patent Application Publication
(10) Pub. No.: US 2015/0066780 A1
(43) Pub. Date: Mar. 5, 2015

(54) Developing Music and Media

(71) Applicant: AudioCommon, Inc., Chelmsford, MA (US)

(72) Inventors: Philip James Cohen, Chelmsford, MA (US); James Christopher Dorsey, Chelmsford, MA (US); Frank Permenter, Cambridge, MA (US)

(21) Appl. No.: 14/034,623

(22) Filed: Sep. 24, 2013

Related U.S. Application Data
(60) Provisional application No. 61/874,066, filed on Sep. 5, 2013.

(51) Int. Cl. G06Q 10/10

(52) U.S. Cl. CPC G06Q 10/101
USPC 705/300

(57) ABSTRACT

Among other things, contributors (also called teammates) can form teams to cooperatively create original media using electronic communication with a server. The cooperative creation of the original media occurs as a project and as working sessions within a project, defined within a user interface accessible to each of the contributors of the team. The contributors can communicate through the user interface. Security is provided against access by any other party to the original media and the process of cooperatively creating it.

This application is entitled to and claims the benefit of the filing date of U.S. provisional application 61/874,066, filed Sep. 5, 2013, and incorporated in its entirety here by reference.

### TECHNICAL FIELD

This description relates to developing music and media.

### BACKGROUND

Traditionally, music or media is developed in a studio that provides suitable facilities for sound recording, mixing, and post-production processing. To produce a final piece of music or media, multiple rounds of recording, mixing, and post-production processing may take place, each followed by comments or including adjustments made to a previous round of recording after listening to the recorded piece from the previous round. This team-driven collaboration and feedback loop often starts even before the formal recording process, during the early stages of the songwriting and media creation, and persists throughout the entire creation pipeline.

### SUMMARY

In general, in an aspect, contributors (also called teammates) can form teams to cooperatively create original media using electronic communication with a server. The cooperative creation of the original media occurs as a project and as working sessions within a project, defined within a user interface accessible to each of the contributors of the team. The contributors can communicate through the user interface. Security is provided against access by any other party to the original media and the process of cooperatively creating it.

Implementations may include one or a combination of any two or more of the following features. The contributors are geographically separated. The working sessions occur one after another. The working sessions occur in parallel. The contributors of the team can communicate by commenting on discrete elements of the original media being created. The contributors of the team can engage in messaging through the user interface.

In general, in an aspect, a user interface is presented on a workstation or mobile device that enables a contributor of a team that is to cooperatively create original media using electronic communication, to become a member of the team. Features are presented in the user interface that enable the contributor to (a) participate in a defined project associated with the creation of the work, to participate in sessions of the contributors, and to communicate with other contributors of the team.

In general, in an aspect, a user interface is presented on a workstation or mobile device that enables a contributor of a team that is to cooperatively create original media using electronic communication and native device media capture, to navigate a hierarchy. The hierarchy organizes information associated with the creation of the original media. The hierarchy includes a project level, a session level below the project level, and a level below the session level that encompasses elements of less than all of the original media. Access of the contributor is controlled at the project and session levels of the hierarchy and access is controlled to each of the sessions at the session level.

In general, in an aspect, a library of files and data associated with projects for the creation of original media by teams of contributors is maintained persistently on a server. Files and data can be added to, removed from, checked out of, or otherwise accessed in the library by authorized contributors of the respective teams. Identification information about contributors of each of the teams is persistently associated with their projects. An active control is presented through a user interface to each of the contributors to enable linking to any of the contributors of the team. When a file or data is checked out by an authorized contributor of one of the teams, identification information is included about each of the contributors of the team who is associated with the file or data that is checked out.

In general, in an aspect, contributors of a team who are creating original media can communicate with one another by a selected one or more of the following modes of communication: private text communication from one of the contributors to another one of the contributors, private text communication from one of the contributors to two or more of the other contributors, public text communication among all contributors of the team who are authorized to participate in communication with respect to a project associated with the creation of the original media, or with respect to a session within the project, and text or audio comments on the project, the session, or a track of the session.

In general, in an aspect, contributors of a team who are creating original audio media can communicate by text or verbal audio comments that are posted through a user interface that is presented to each of the contributors and are stored at a server accessible to all of the contributors. The contributors can associate each of the text or verbal comments with an element of the original audio media being created. The element comprises one or more of: a point or region within an audio track of the audio media, an entire audio track, a session of cooperative work on creating the original audio media, and a time synchronized comment as part of a comment for a session.

In general, in an aspect, a user interface is presented to contributors of a team who are creating original multi-track media. The user interface enables each of the contributors to provide text or audio comments on each of the tracks and to participate in text threads with other contributors. A contributor of the team, within a single user interface presentation, can review each of the text or audio comments, read a corresponding text thread, and see an image or avatar representing another contributor who was the source of the text or audio comment.

In general, in an aspect, a user interface is presented to contributors of a team that is creating original multi-track media. The user interface enables each of the contributors to cause information of the state of a project to be saved persistently. The state information includes solo, mute, and fader of each track of the media, versions of each track, and comments associated with activated versions of the tracks. Each contributor of the team can, through the user interface, invoke the persistently saved state information of the project to cause the user interface to display the project in the corresponding state.

In general, in an aspect, through a user interface, contributors of a team that is privately creating original multi-track media can cooperate electronically in the creation of the media. The user interface represents tracks associated with the media, private communications among contributors of the team, and information about the contributors of the team. Each of the contributors of the team can share at least portions of individual tracks of the audio media in an unfinished state through publicly available social media, without sharing the private communications and without sharing the information about the contributors of the team.

In general, in an aspect, information is incorporated into a file that conforms to a defined file format and is associated with original multi-track content. Information is included in the file that represents individual tracks of the audio content. Information is included in the file that defines a mix-down of the individual tracks. Metadata is included in the file that is associated with the creation of the audio content. File type information is included that enables rendering of the metadata as intended.

In general, in an aspect, a user of a device that presents publicly available audio-video content to the user can locate and have presented to the user a file of information about tracks that underlie the audio-video content and information associated with the creation of the audio-video content.

In general, in an aspect, contributors of a team can create original media cooperatively in sessions that are part of projects. Metadata is accumulated that is associated with the creation of the original media and that includes the identities of contributors to individual parts of the original media, the contributions of the contributors, and costs associated with the creation of the individual parts. The accumulated metadata is made available for analysis.

In general, in an aspect, contributors of a team, who are cooperatively engaged in a project to create original media, can monitor progress on the project by displaying a project matrix including rows each of which represents a session of the project and columns each of which represents on the session. The columns include details related to tracks of the original media or checklist items.

Implementations may include one or a combination of any two or more of the following features. Each of the contributors of the team can, through an online facility, control the content of each of the blocks within the matrix including activating the block, marking the block is complete, or permitting the block to remain inactive. With respect to each of the rows, an indicator of the progress is displayed on the corresponding session based on the status of blocks in the row.

In general, in an aspect, contributors of a team, who are cooperatively engaged in a project to create original media, can monitor financial information about the project by displaying a two dimensional budget graph in which the vertical axis represents budget or cost amounts and the horizontal axis represents a time line. Any of the contributors can control the information represented on the vertical axis by entering overall budget, budget line item, and cost information and control the information represented on the horizontal axis by entering at least start and end date constraints.

Implementations may include one or a combination of any two or more of the following features. A trajectory line of the budget is displayed for the period of the project on the budget graph. At successive times, additional segments are displayed of a second actual expenditure line on the budget graph based on an automatic computation from cost information entered by the contributors. The trajectory line is based on an aggregation of projected budgets sub-items.

In general, in an aspect, an online facility is provided that serves as a marketplace for original media and services associated with original media. The online facility includes features that represent the marketplace in terms of projects and sessions associated with the creation of original media.

Implementations may include one or a combination of any two or more of the following features. Contributors of a team that is creating original media can add members to the team from time to time using the features that represent the marketplace in terms of projects and sessions associated with the creation of the original media. The marketplace provides a medium to buy and sell the original media and services associated with the original media. The medium enables contributors of an existing team to buy and sell original media and services among them. The medium enables contributors of an existing team to buy and sell original media and services from parties who are not part of the existing team. One of the features of the marketplace comprises a search feature based on one or a combination of two or more of the following characteristics: roles of service providers, instruments played, associated bands, associated projects, geographic location, and expected compensation.

In general, in an aspect, contributors of a team who are cooperatively engaged in a project to create original media, can participate in the creation of the original media through apps that run on mobile devices and interact with a server. The participation includes enabling each of the contributors of the team to record, organize, and share draft recordings with other contributors of the team. Each of the contributors of the team can attached photographs to projects and sessions associated with the original media on the server.

Implementations may include one or a combination of any two or more of the following features. The participation comprises interacting with projects maintained on the server. The interacting including at least one of the following: viewing, creating, editing, and reviewing a project; creating a new project; inviting other people to join the team associated with the project; accessing and interacting with sessions and tracks associated with the project; and managing contributor's profile on the server.

In general, in an aspect, a contributor of a team of contributors who are cooperatively engaged in a project to create original media, can synchronize an audio file of a master digital audio workstation session of the contributor, with the timing of a track of a session that is shared through a server by multiple contributors of the team. The contributor can enter a start time of the audio file of the contributor's master digital audio workstation session. A time ruler of a track that is shared through the server is automatically calibrated to have the entered start time as its origin or starting point. These, and other aspects, features, and implementations, and others, can be expressed as methods, methods of doing business, apparatus, systems, components, software products, means for performing steps or functions, and in other ways.

Other features, objects, and advantages will be apparent from the description and drawings, and from the claims.

### DESCRIPTION OF DRAWINGS

FIGS. 1-6, 8, 17, 18, 27, and 43-45 are block diagrams.

FIGS. 7, 9-16, 19-21, 23, and 25 are example screen shots or example parts of screen shots.

FIGS. 28-36 are schematic views of example user interfaces displayed on screens of mobile devices.

FIGS. 22, 24, 26, 37-42 are flow diagrams.

### DETAILED DESCRIPTION

### Overview

The systems described here offer a new paradigm for media production we call social media and music development (SMMD). In this paradigm, teams of artists, writers, producers, sound engineers, studios, enterprises, management teams, academic institutions, educators, and other parties can create new media through online collaboration, outside the physical realm. Teammates can access music and media projects, communicate with teammates, manage schedules and budgets, and grow their production team(s) through the use of only a web browser or mobile device. The systems also creates new opportunities for public interaction and fan outreach, in that teams can share a new type of music/media content we call Stem File Format (SFF) on social networks, or invite fans to edit or remix their projects through a public web interface. These innovations open up new opportunities for the entire music and media industries and may fundamentally change the way media and music is created, organized, and shared.

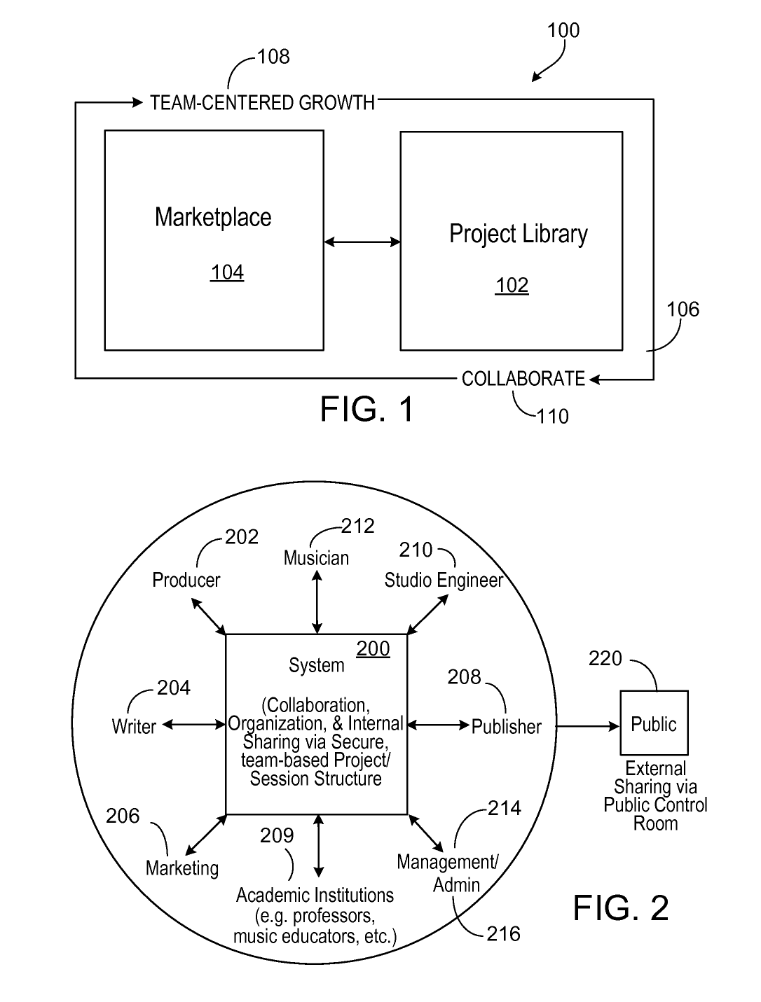

An example of a system 100 that embodies the SMMD paradigm is shown in FIG. 1. Components of the system include a project library 102 and a marketplace 104. The project library is a repository for a user's recording projects. The marketplace is an online community in which users can solicit business from other music and media professionals, advertise their services, and grow their production teams.

Another example of a system 200 (which can be the same or different from the system 100 of FIG. 1) is shown in FIG. 2. Users of this system 200 may include producer(s) 202, writer(s) 204, marketing 206, publisher(s) 208, academic institutions 209, studio engineer(s) 210, musician(s) 212, and management 214. Users of this system organize into teams and collaborate on new media in a secure and private online environment. Media generated by private collaboration can be shared with fans using the public control room 220, a public web interface to generated media. Team administrators 216 manage public sharing and other system features.

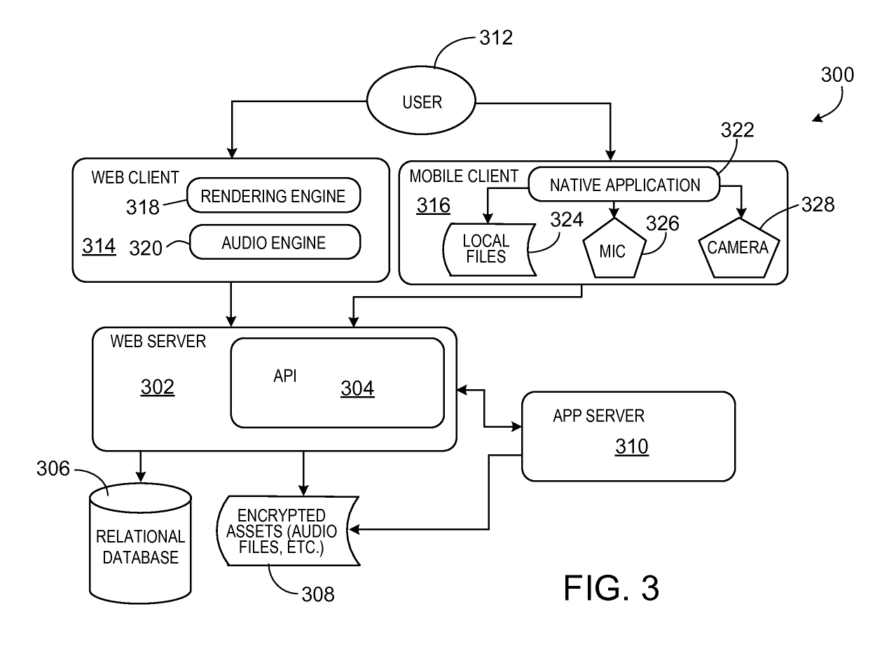

Referring to FIG. 3, an example architecture of a system 300 (which can be the same as or different from the system 100 or the system 200) is shown. This figure illustrates system components and their inner structure(s) as well as system interfaces exposed to the user. As shown, a user may connect to a web server 302 through a web client 314 or a mobile client 316, both of which may be a machine including a processor. The web client 314 may include a rendering engine 318 and an audio engine 320 for downloading and playing a recording project stored on the server 302. The mobile client 316 may include one or more native applications 322 that capture content using a microphone 326, and a camera 328. Content can be stored in local files 324 or on the web server 302. Local files 324 may also be transferred from the mobile client 316 to the webserver. The webserver 302 communicates with the web and mobile clients using an application programming interface (API) 304. The webserver 302 relies on several application servers 310 dedicated to specific tasks such as file compression of large user generated audio files. In addition, the webserver connects to one or more databases 306 and encrypted assets 308 that store recording projects and user account information.

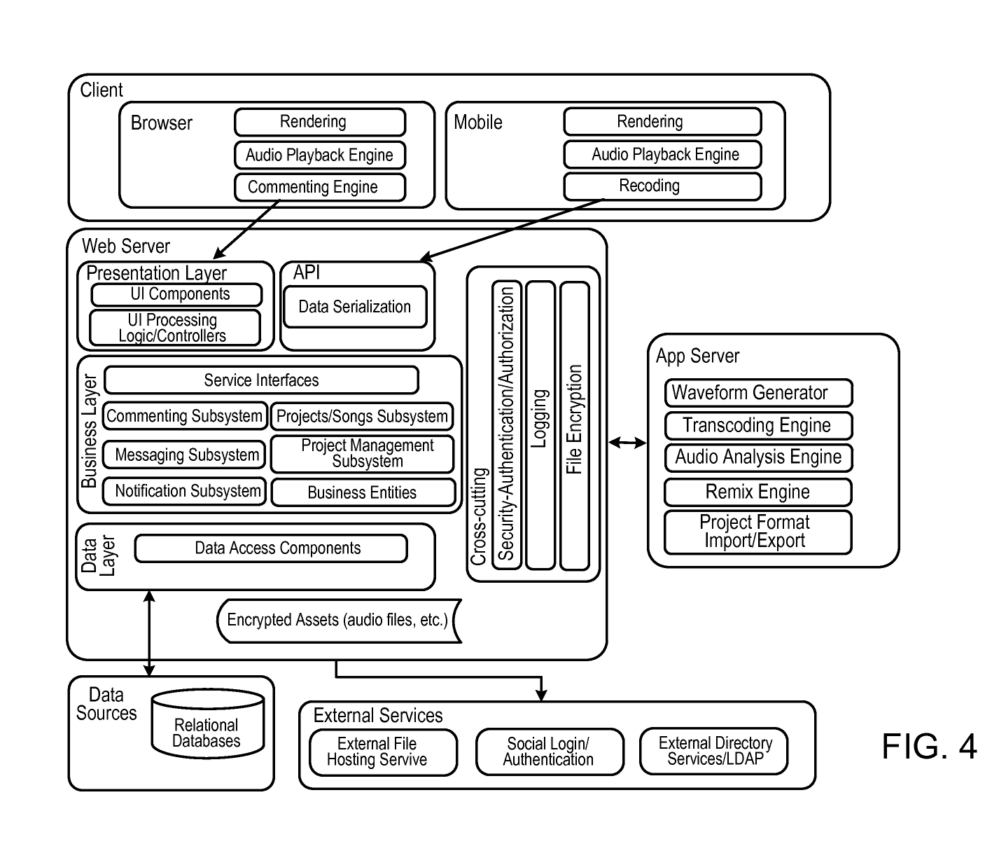

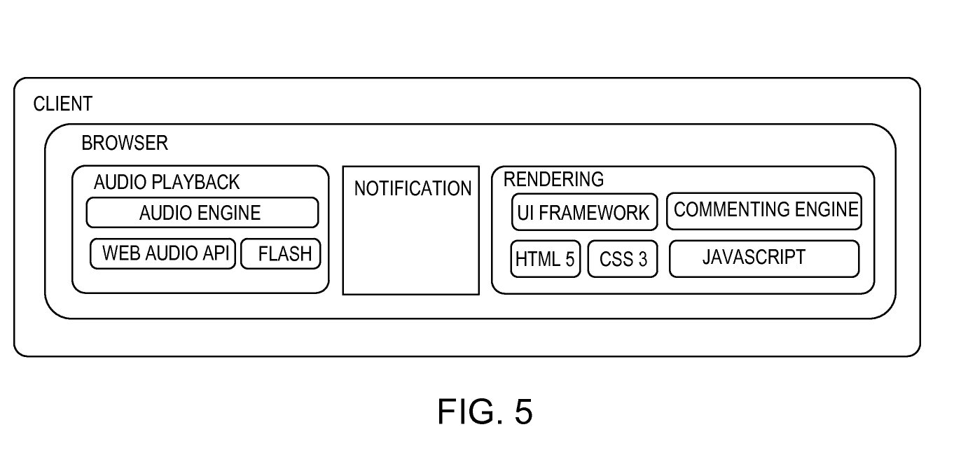

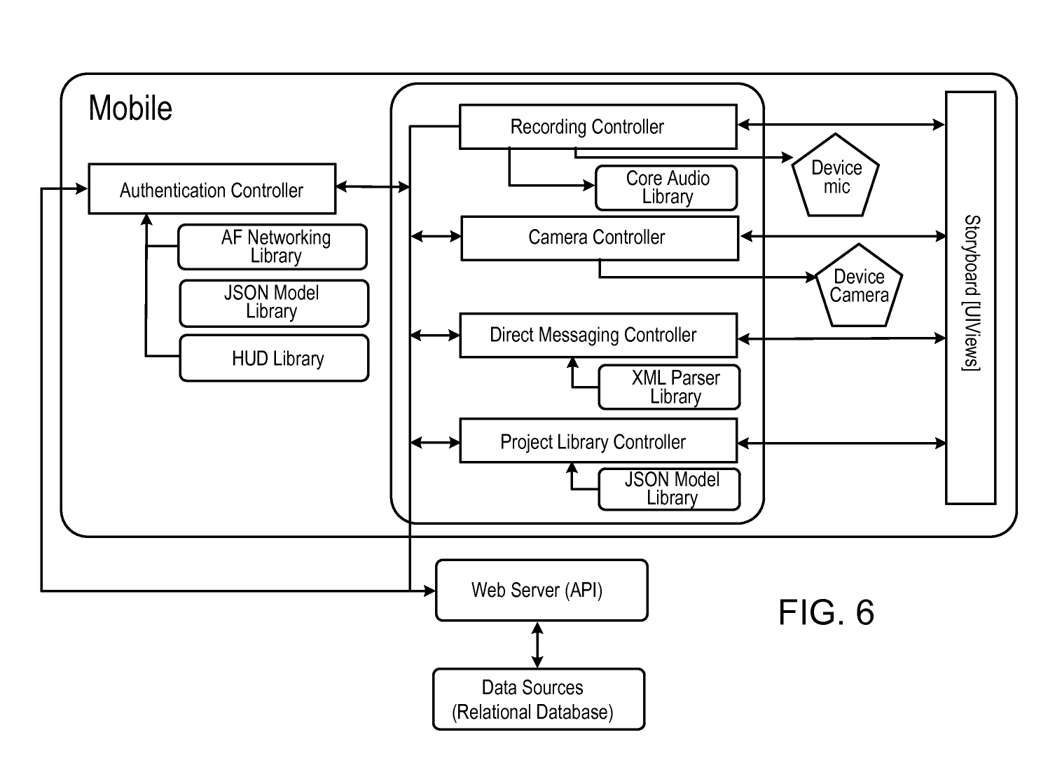

FIG. 4 shows an example of a detailed architecture of the system 300 of FIG. 3. Furthermore, FIGS. 5 and 6 show examples of detailed architectures of a web client and a mobile client discussed in the system 300 of FIG. 3.

### Examples of Implementations

### 1. Project Library and Living Electronic Portfolio (LEP)

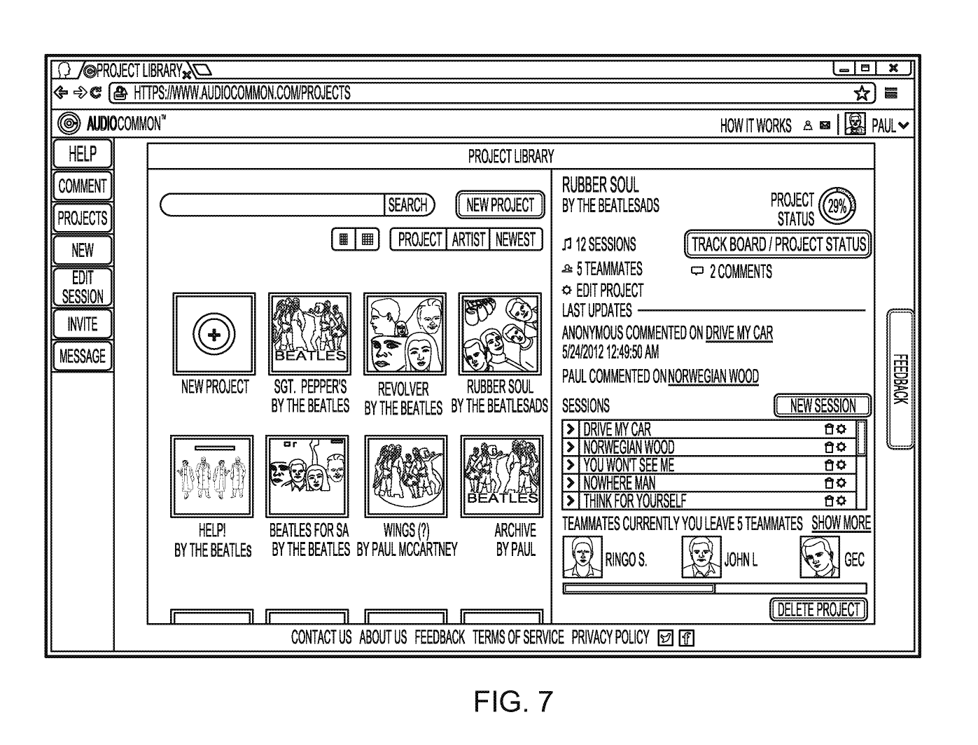

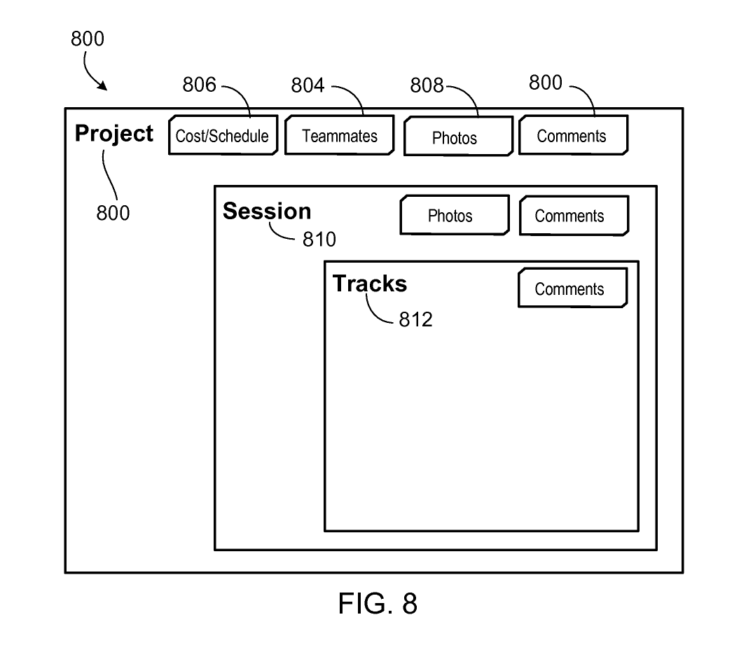

The project library provides an interface to music and media projects stored on the webserver. It can be accessed through a web browser or through the mobile client. An example of a project library is shown in FIG. 7. The project library organizes the user's media and collaborations into a hierarchy of folders, projects, and sessions. Folders are at the top of the hierarchy and allow a user to group related projects. Projects are next in the hierarchy and have the internal structure depicted in FIG. 8. This structure includes a list of teammates 804 (or collaborators), management tools (e.g., a recording progress indicator known as a track board, a cost and scheduling tool 806, etc.), and media (audio files, photos 808, etc.). Sessions 810 form the level of the hierarchy below projects and organize related audio/media content and teammates (either a segment of the overall project team or the entire team). Audio content is stored inside tracks 812, which represent the bottom of the hierarchy. In typical applications, a project represents an album, a session represents a song, and a track represents a musician's contribution to a song (e.g., a single vocal performance).

Access permissions to project and/or session content are granted to teammates by a project administrator. A teammate's permissions can be tailored to the teammate's specific project role. For instance, a producer may be granted full access to project content (e.g., teammates, sessions, communication actions, etc.), whereas a guest musician may be granted permissions to one specific session. For efficiency, administrators can design access policies appropriate for each general type of user (e.g., musician, producer, songwriter, etc.). These policies can be quickly applied as a user joins a team and further customized depending on the administrator's preference.

A user can participate in multiple projects simultaneously and can add new projects to his library at any time. In turn, a project can contain multiple sessions, and the number of sessions within a project can grow over an indefinite period. A user can also construct a project that contains no sessions if he/she wishes open up a team communication without music or media, or to build a team around project management tools (e.g., the cost and scheduling tool 806).

The project library displays all projects and project file folders (within which there could be multiple projects). When a user with proper authorization clicks on a project within the project library, the information within the project library either scales to represent the project's contents, or the user is taken to a dashboard which shows the project's contents. Each of these paths yields a detailed representation of a project that may include a project's teammates, sessions, communication actions (e.g., personal direct messaging and team commenting at the project and session levels), and other details about the project.

As a user clicks from project to project, the display for the earlier clicked project disappears and information about the newly clicked project appears. For example, the information scales to the project's specific collaboration environment (e.g., project-specific teammates, messages, photos, sessions, etc.).

The project library also includes a persistent cloud-based archive called the living electronic portfolio (LEP). Within the LEP, data additions or subtractions may be made and project teams remain intact over time. This extends the current music and media creation paradigm from a finite period of time to an event that lives on in perpetuity. The LEP or the cloud-based archive facilitates music and media creation, due to the inherent team-based structure of the production activities.

Cataloguing data under the LEP can be important and advantageous (e.g., in situations where there is a need to maintain a project-specific or session-specific archive, iterate on a project or session, and communicate with project-specific or session-specific teammates over time).

As an example, each file within a user's LEP is hosted on the cloud; and each teammate icon displayed within each project and session has an active link to the teammate's profile which includes his personal contact information (e.g., personal e-mail address). Though projects and sessions can be saved and archived, these projects and sessions are always living, such that members of a team can always use a given project or session as a communication portal to reach other teammates on the project or session. In some implementations, certain members of the team may always be able to augment the data within the given project or session. Furthermore, if a user exports a specific project or session from the system or platform (e.g., downloads to the user's local machine) to edit or modify the audio/media, the applicable system metadata (containing project-related attributes) may, for example, be attached to the downloaded project or session. Thus, the team's imprint is allowed to live on with the exported media.

### 2. Avenues of Communication

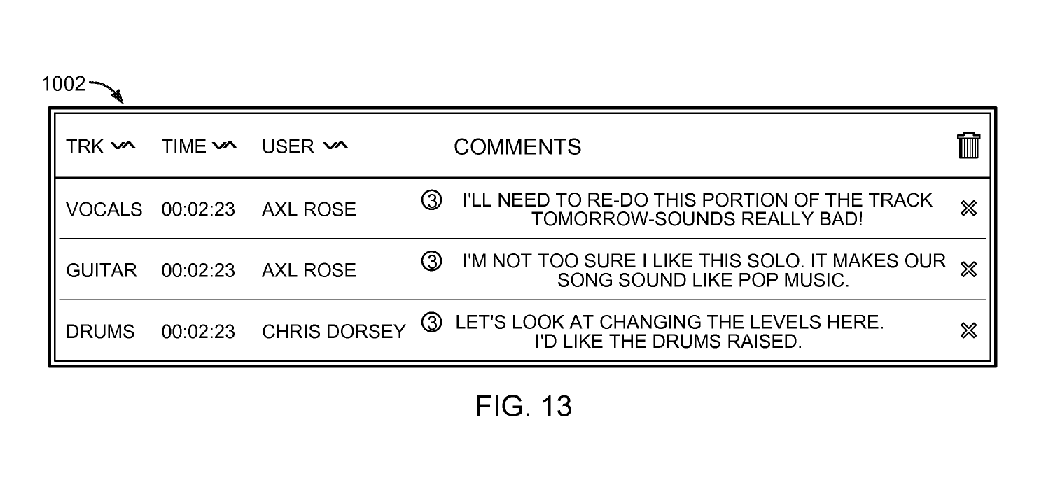

With regard to team communication within the project and session structure, we discuss four primary forms, which can be used individually or in combination. Other forms of communication can be used, too.
Person-to-person direct messaging. Only the individuals within a message chain can see the messages. These messages can be initiated by clicking on a profile picture icon or on the messaging button.
Person-to-multiple people direct messaging. Only the individuals within the message chain can see the messages. These messages can be initiated by entering multiple user names within the message window (after clicking on the message button), or selecting a group or team from a list within the messaging function.
Team messages at both project and session levels. An example of such messages is public posts for the entire project or session team to see.
Audio commenting at the project and session levels using the dashboard and the virtual control room (VCR), which are discussed further below. To comment on audio, users can submit text-based comments as shown in FIG. 13 or record and submit a spoken critique (in the form of words and/or music melody) using a webcam, microphone, mobile device, or other sound-capture medium.
These forms of communication can provide the participants (or community) of the system the dexterity needed to create music and media across geographic boundaries. The first three forms facilitate project management and general team interactions. The fourth form allows users to give clear, unambiguous feedback on a project, session, or track, and can be further broken down into the four subcategories discussed below. Point/region comments: Point/region comments are associated with an individual audio track and pertain to a specific region of time. A marker associated with each comment identifies this region of time on the track waveform. The width of the marker matches the specific length of time that is represented by the region marker. The marker is a single point of minimal width if the comment pertains to a specific instance of time. Point/region comments are initiated by clicking within a track's waveform in the displayed VCR.
Track-wide comments: these comments similar to point/region comments, but pertain to the entire length of the track. A track-wide comment describes a general issue that is not isolated to a specific region of time. Track-wide comments can be created by clicking on a track icon within the VCR or the dashboard, and may be represented by highlighting a track's entire waveform.
Session-wide comments: these comments pertain to a general issue with the entire session and do not pertain to a specific track or region of time. These comments can be created by clicking on a session comment button within the VCR. Session point/region comments: these comments are displayed when a session is viewed in the dashboard. These comments describe an issue specific to an instance or region of time that pertains to the entire session. A marker labels this region of time on the session waveform displayed in the dashboard. The session waveform is generated by consolidating a session's tracks into a single file. Consolidation can be initiated by the user in the VCR or automatically by the webserver. These comments are made by clicking on a point or region within the session waveform displayed in the dashboard.

The comments in any of the above discussed forms, or other forms, are associated with the users that submitted them. Users can submit comments as text or as recorded audio. A discussion thread is also created for each comment. In this thread, users can reply to the contents of the comment and initiate corrective actions. All comments can be seen by the members of a given project or session team to whom access has been permitted by, for example, a project's administrator. Access to each discussion thread is similarly controlled.

In some implementations, the majority of audio commenting takes place within the secure, team-based structures of a project's dashboard and VCR. The system may also provide an additional, public means of communication that allows users to start a social conversation around publically shared audio content. This avenue of communication is detailed in the public control room discussion below.

### 3. Dashboard

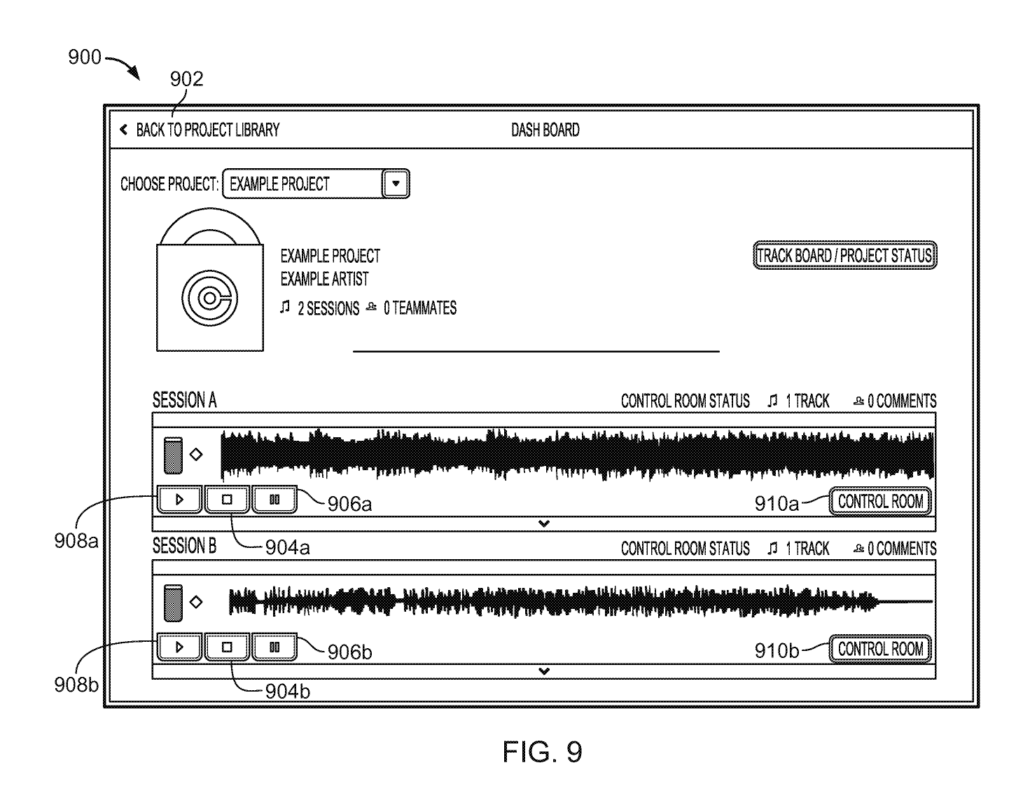

In some examples of the system that we are describing, a dashboard is provided that is one level down in the hierarchy from the project library. While the project library displays projects within a user's overall portfolio, the dashboard displays the contents contained within a selected project (e.g., teammates, messages, photos, sessions, etc.). As shown in FIG. 9, a user can access the dashboard from the project library or can return to the project library from the dashboard using a link 902. The dashboard provides a streamlined interface 900 into a user's projects and sessions. For example, multi-track session information is condensed into a single track (either on the system's servers or inside a user's browser) to allow a user to see more than one session per display page (Sessions A and B in the figure). Each session can have an independent play button 908a, 908b, and stop button 904a, 904b, pause button 906a, 906b, as well as a direct link 910a, 910b to the control room.

Within the dashboard, each session is marked by a consolidated audio file (e.g., one originated from consolidating multiple tracks from the VCR or a cumulative audio file). Each session through the dashboard has its own team communication and collaboration medium where one or more of the previously discussed communication forms can be implemented (including track-wide and session point/region audio commenting).

Each session box can contain a version dropdown. This menu allows users to quickly and easily change session versions. The session versions can be initiated in the control room using a “Save Mix” function (discussed below).

The dashboard can be built on top of one or more of JavaScript®, Flash®, and HTML5®, using essentially the same or similar technology used to develop the VCR, which is discussed in more detail in the next section.

### 4. Virtual Control Room (VCR)

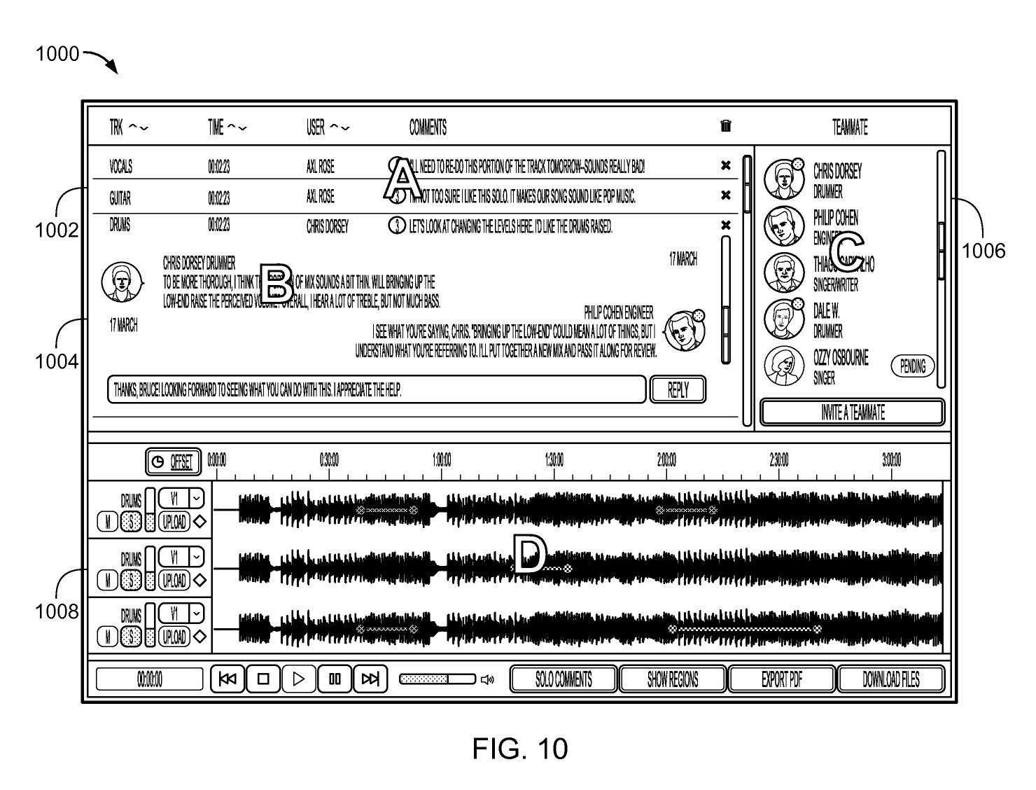

The VCR is one level down in the hierarchy from the dashboard. The VCR can be built on top of the Chrome® Web Audio API, Adobe® Flash®, or HTML5®, which enables wide browser and device support. While the dashboard displays the sessions within a project, the VCR displays the content within a selected session (e.g., teammates, communication actions/information, tracks, etc.). Referring to FIG. 10, an example VCR 1000 contains four primary components 1002, 1004, 1006, 108 (also marked as A-D in the figure):

A. Comment List 1002: the area that displays comments within the session (including point/region, track-wide, and session-wide comments);

B. Conversation Panel 1004: the area that displays each conversation thread specific to a point/region, track-wide, or session-wide comment;

C. Team List 1006: the area that displays the teammates specific to that project or session;

D. Waveform and Commenting Interface 108: the area that displays a session's audio tracks/primary media and comment markers.

These features work together, and can be used together, to allow users to listen to and comment on audio/media data.

The comment list (A), displaying one or more (e.g., all) comments pertaining to the session, can be stored on the system's servers and be fetched or updated using HTTP requests and queries. Other methods can also be used. The conversation panel (B) contains an expanded view of the selected comment as well as replies from teammates pertaining to the comment (a conversation thread). JavaScript can be used to coordinate the interface between the panel and the comment list. In the list of teammates (C), the status of each teammate, such as being offline or online, can be indicated. Data for this indicator can be supplied using server-to-browser communication. In the interface 108, the multi-track wave data and various audio playback control buttons are displayed. Audio can be played and waveforms can be displayed using technologies supported by the user's browser. Markers can be displayed on top of the waveforms to denote comments. Each marker corresponds to an item in the comment list. The selected marker and selected comment may be coordinated using JavaScript. Although FIG. 10 shows a particular arrangement of the different VCR features, other arrangements can also be used. In some implementations, each component 1002, 1004, 1006, 1008 is displayed in a separate window that is a part of the display of the VCR. Each separate window may be movable or can be canceled by a user.

### I. Waveform & Commenting Interface

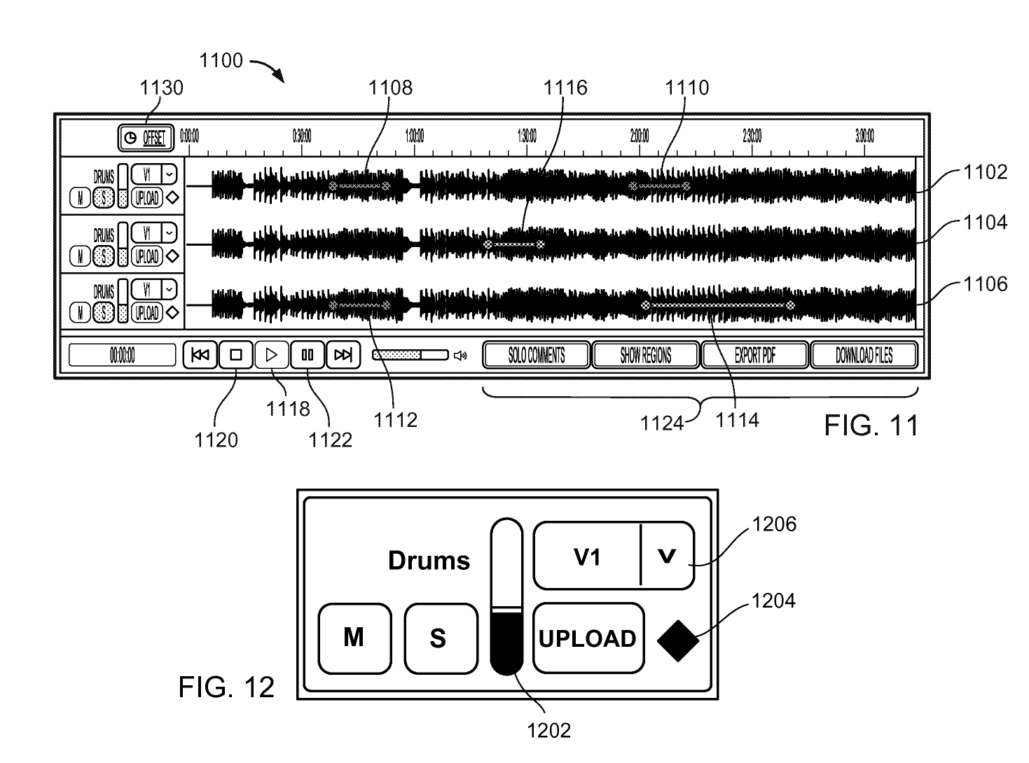

Referring to FIG. 11, a track window 1100 displays a session's various tracks 1102, 1104, 1106 in waveform view. Such views can allow a user to quickly and easily mark point(s) or region(s) within a track's waveform image by clicking on the specific point(s) or region(s) on which the user plans to start a conversation or input a comment.

When a user clicks on a point or region in a waveform, he/she is asked to enter a comment. After the comment is entered, and the user clicks “Enter,” the comment is time-synchronized with the indicated point or region and aggregated in the VCR's comment list and a conversation thread placeholder is attached to the comment in the conversation panel.

Within the track window 1100, point/region comments are annotated by markers 1108, 1110, 1112, 1114, 1116 in the respective waveform. Each marker signifies the position and duration of the comment within the track's overall time signature. In addition, track-wide comments can be entered by clicking on a track's track-wide commenting icon. In some situations, similar to the point/region comments, these track-wide comments are included in the comment list, and a conversation thread placeholder is initiated.

Referring to FIG. 12, which shows a part of the window 1100, each track within the track window 1100 can be muted (using the “m” button) and soloed (using the “s” button), and each track's level or volume can be controlled by its independent fader 1202.

Additionally, the track's overall placement in the stereo field (e.g., panning to the left or right) can be controlled using either a horizontal fader or a control knob. Each track also has an “Upload” button 1204 and version dropdown menu 1206. The “upload” button allows users to upload different versions of a track, and the version dropdown gives users access to the different versions of a track.

### II. Comment Toggle Functionality

Referring again to FIG. 11, buttons for play, stop, and pause can be included to easily control the audio's/media's playback. At the bottom of the track window 1100, next to the play button 1118, stop button 1120, and the pause button 1122 are comment toggle buttons 1124. These buttons 1124 allow a user to quickly and easily move from one comment marker to another comment marker (within the track window). As a user moves from one marker to another, the track specific to the activated comment is soloed. If comments are submitted as recorded audio, the audio of a comment takes precedence over the audio of the track. However, users may switch back-and-forth (from comment audio to track audio) with the click of a button during playback.

Additionally, users can download a session's text-based comments to a consolidated file (e.g., a PDF file), and can download a session's audio tracks by clicking on the respective download buttons in the track window 1100.

### III. Offset Tool

Within the track window 1100, there is also a track timing offset tool 1130. The tool can aid in the time-synchronization of audio files between one's local master digital audio workstation (DAW) session and one's online system session. A user can enter the master-session-specific start time (usually from an external DAW) of a particular audio clip in the system. After this information is entered into the tool, the track window's time ruler is automatically calibrated, using the entered start time as its origin or starting point.

### IV. Comment List

Referring again to FIG. 10 and to FIG. 13, the comment list 1002 displays the various audio comments within the session (including point/region, track-wide, and session-wide comments). This list can be time-synchronized and aggregated, and can be sorted or deleted (e.g., automatically by the system, by an administrator, or by a user). Comments in this list can be attributed to a session, a track, a user, and/or a time.

### V. Conversation Panel

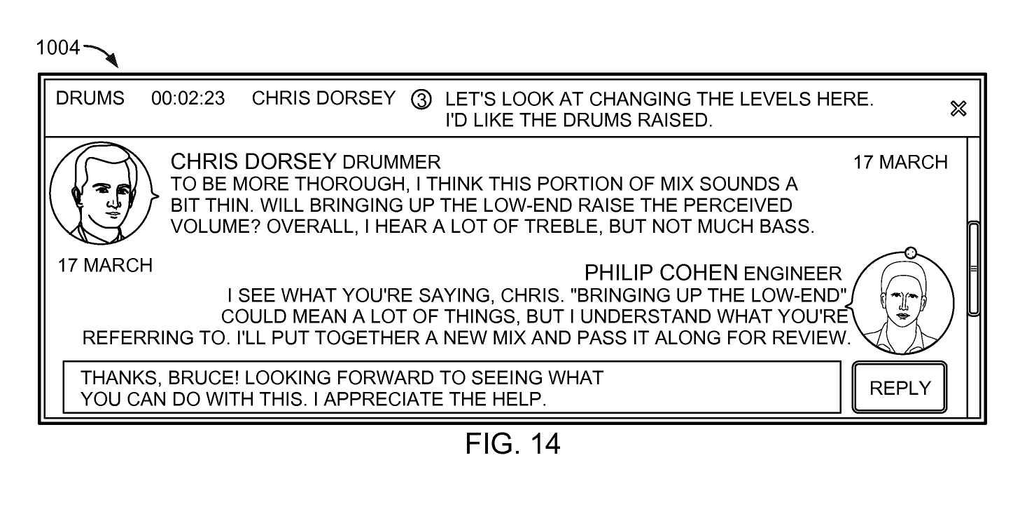

Referring to FIG. 14, the conversation panel 1004 displays the conversation thread specific to a point/region, track-wide, or session-wide comment. A user may activate the “reply” button to continue the conversation thread.

### VI. Team List

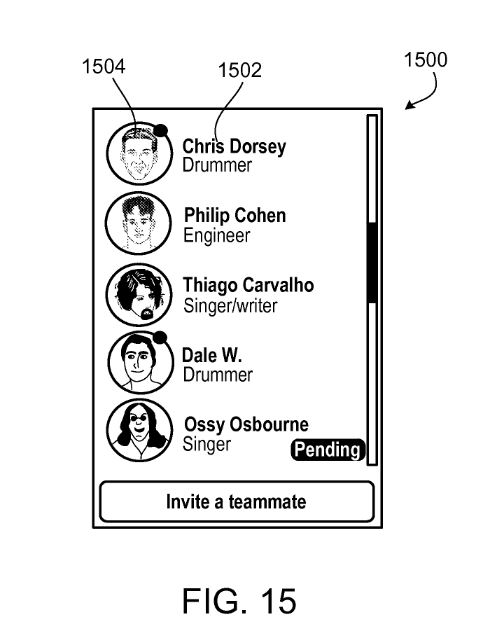

Referring to FIG. 15, a teammate window 1500 displays teammates for a project or session. Visual indicators may highlight whether a teammate is currently on the platform (“online”) or off the platform (“offline”) Links can be provided such that when activated, the teammate's public profiles are displayed. The links can be embedded with the names 1502 or the profile pictures 1054 of the teammates, or at other locations if the window. There are also other links, such as links to a secure direct message portal between a user and a particular teammate or links 1506 that allow a current teammate to invite a teammate to join the team.

### VII. Save Mix

The VCR may also have the “Save Mix” functionality. Clicking on the “Save Mix” button allows users to save the current/activated state of the VCR. This “Save Mix” feature may account for (that is, the state that is saved may include) the following: individual track solo, mute, and fader states; individual track versions; and comments specific to the activated versions. Users can implement or revert to a saved mix (either his own mix, or one of his teammate's mixes) by clicking on the “Mixes” button and selecting a mix from the list.

In some implementations, a stripped-down version (e.g., consolidated waveforms, no point/region comments, etc.) of each saved mix is accessible on the dashboard.

### VIII. Public Control Room

As explained, the system of this disclosure not only allows a user to share music and media within his project or session teams, but also enables the user to share other new types of media content with an outside social sphere, if he/she so chooses. For example, the system allows each user to share a sterilized or stripped-down version of the VCR by removing details about the teammates and the internal team communications. The public control room allows for sharing music and media content at any (e.g., the earliest) stage of the creative process, to give the public a new look inside the process of music and media creation.

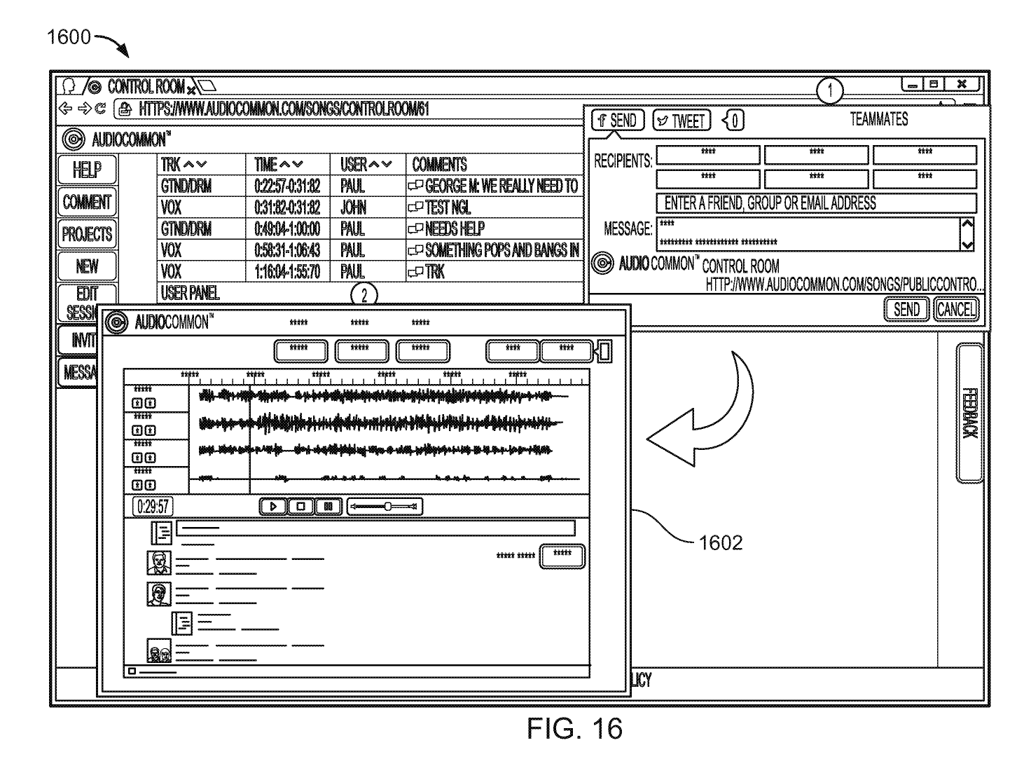

As an example, referring to FIG. 16, a public control room 1600 displays a session's tracks 1602 and is integrated with popular social media sites for easy sharing and social commentary. The content displayed through the public control room may be multi-track audio and other media files. The displayed content allows fans to interact with music in a new way. With respect to the public control room, and for other purposes, the system defines a so-called stem file format (SFF) for music and media content. The format can enable a saving in storage space and permit an interactive music-listening experience.

The SFF is a digital container format that enables the packaging of multi-track data into a single file, which may contain both the stereo and mono mix-down of the file, as well as the individual audio files (e.g., tracks) that make up the mix. This format can also contain other metadata related to the audio file(s), including but not limited to the recording hardware used (microphones, mixing boards, etc.), instruments used, effects used, date of recording, author, musician, commentary, other products/software used in the recording of the track, or any other data of interest. The metadata can include the appropriate mime-type of the metadata, so that an appropriate application or plugin can be used to render the metadata as intended. Sequences of audio that are repeated (e.g., in loops) can be stored once in the file with time offset references of where they should exist in the final track. Significant storage space can be saved. An audio player that understands (for example, is able to parse the metadata of) SFF can re-create the audio tracks based on the data contained in the file. Optionally, the SFF container may point to external resources instead of packaging the resources physically in the file. Upon playback (using either the platform or an SFF-compatible player) the player can load the external resources (either stored locally or obtained using a Uniform Resource Identifier, or URI).

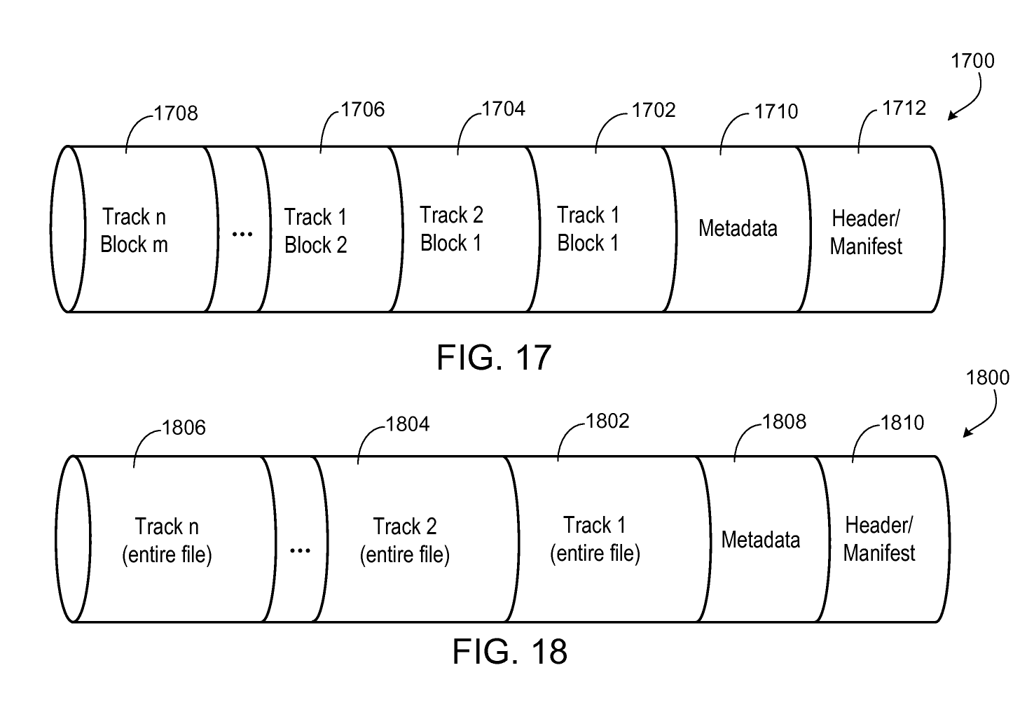

Audio files stored in SFF containers can either be stored sequentially in their entirety or be “chunked.” For example, FIG. 17 shows an SFF container 1700 that stores an audio file that has been chunked into blocks 1702, 1704, 1706, 1708 for different tracks. The SFF container 1700 also stores at least a header 1712 and metadata 1710. In contrast, FIG. 18 shows an SFF container 1800 that stores multiple tracks 1802, 1804, 1806 in their entirety. Similar to the container 1700 of FIG. 17, the container 1800 also contains a header 1810 and metadata 1808.

SFF containers such as the container 1700 with chunked storage can be streamed to a client machine for playback before the entire file has been downloaded to the client machine. This is accomplished by breaking the audio files into smaller files of a given size (aka chunking), then storing each chunk sequentially in the container file. Playback through the website or on an SFF-compatible player will allow the playback to begin while the container file is still being downloaded (i.e., streaming). This approach can allow the system to overcome the connection limitation inherent in currently available browsers. Sessions with a large number of tracks can begin playback almost instantly, depending on the user's network connection speed. In some implementations, when connected to an SFF-aware server, the client machine can turn on or off tracks (i.e., mute or solo each track), and the server will only send the necessary tracks, for live streaming of multi-track content.

Additionally, the system can identify a particular audio file, either by a known ID (e.g., a song ID) or by an acoustic fingerprint, and can determine whether there is multi-track data available for that song from a database or multiple databases external to the system. If the external resources exist, an SFF-compatible player can prompt the user to download the content and, optionally, the plugin or application used to render the resources. The audio resources can be played back natively in the SFF-compatible player.

In general, the SFF provides users with a new experience around music and media, and new insight into music and media creation. This format will allow a user to understand, explore, and experience music and media in a much more fine-grained and controlled way than is the case with most current file formats.

### 5. Track Board

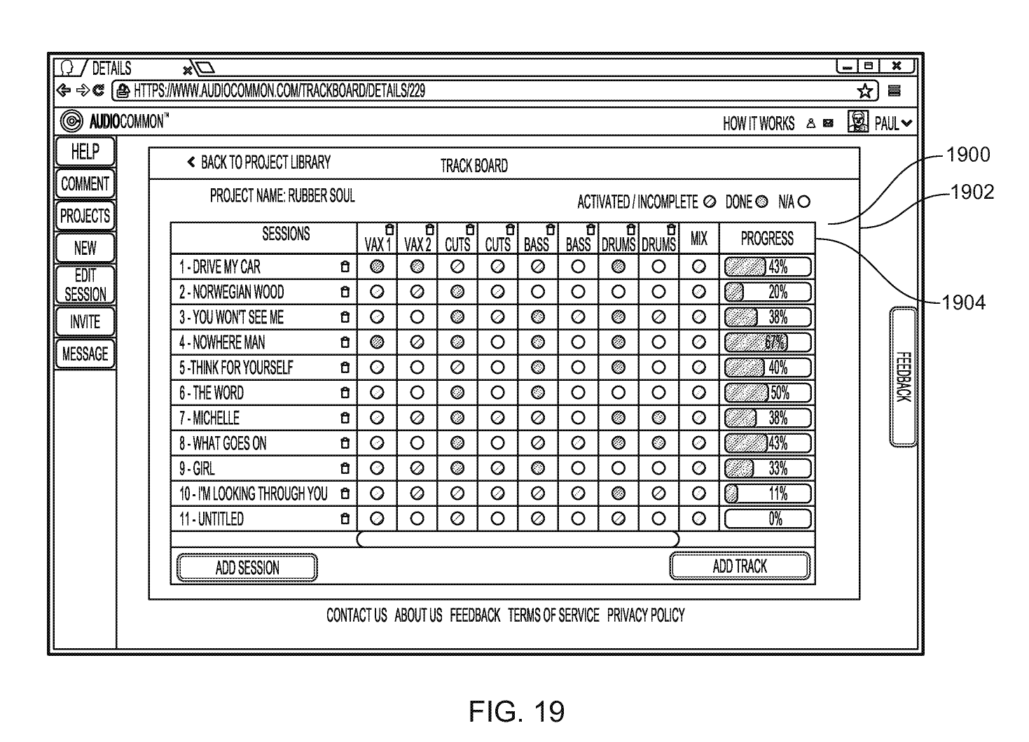

Referring to FIG. 19, an example of a track board 1900 is shown on a display window 1902. The track board 1900 tracks progress throughout the music and media creation process (e.g., for years). The track board can be used as a virtual “To Do” list for music and media production. Session-specific details are annotated across the track board's rows, and track-specific or checklist item details are annotated down columns. Each block within this matrix can be activated, be marked as complete, or remain inactive by, e.g., a simple click of a mouse. Additionally, completion may be determined by other existing session attributes, such as comments made, tasks completed, project administrator sign-off, etc. A progress indicator 1904 is represented at the end of each session's row to give users a quick indication of the progress. In some implementations, the progress indicated by the indicator 1904 is calculated by dividing the number of completed tasks within a row by the number of activated tasks and the number of completed tasks within the row. The progress of the overall project can be deduced by averaging a project's session progress indicators. The information about the process can be displayed on different pages (e.g., on the project library page, within the dashboard, or via the VCR). In some implementations, clicking on the track progress indicator simply toggles the state of the track to the next state; inactive to incomplete, incomplete to complete, and complete back to inactive. Adding a new session defaults all track states for that session to inactive. Adding a new track defaults all of that track's states to inactive for all sessions.

An example of a process 4100 for tracking the status of a session is shown in FIG. 41. When the progress tracking starts (4002), a user clicks (4004) a track/mix indicator. Upon receiving the indication that the user made the click, the system determines (4006) whether the track is active for a session. If not, the system sets (4008) the track to be active. If yes, the system determines (4010) whether the track is complete. If no, the system sets (4012) the track as complete for session. If yes, the system (4014) sets the track as inactive for session. The progress of the session is then calculated (4016). The results are shown to the user by updating (4018) the user interface displayed to the user. The tracking process then ends (4020). 6. Cost/Schedule Tool

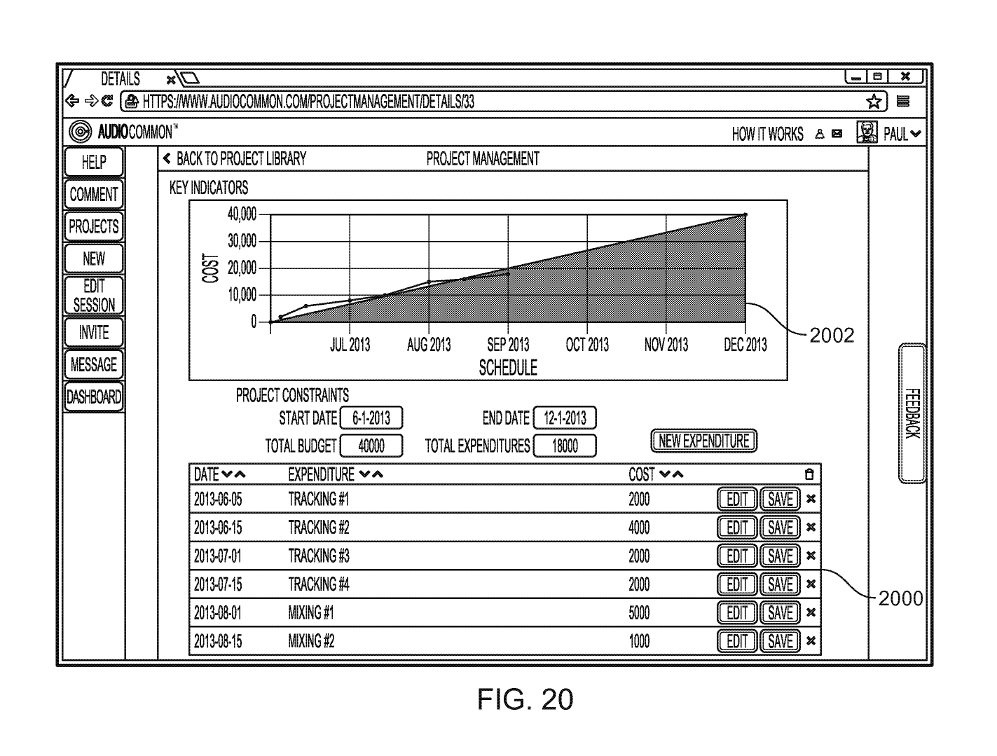

Referring to FIG. 20, a cost/schedule tool 2000 overlays budget, expenditure, and schedule data to give users a quick, visual indication of whether a project or session is on or off track. The tool 2000 also provides users with a living project management archive.

Users may input a project's overall budget, or individual budget line items and cost objects that build into the project's overall budget. This data can be used to populate the y-axis (vertical axis) of the chart 2002. Users may also enter schedule start and end date constraints. This information can be used to populate the x-axis (horizontal axis) of the chart. Users can also supply expected expenditure dates. These dates allow the tool to plot a curve of projected costs. We call this curve the expectation line. If no dates are provided, a diagonal line can be drawn from point 0,0 on the chart to the intersection of the schedule end date and the cumulative/total budget figure at the end date. This diagonal line provides a rough linear approximation of the expectation line and can be refined as users fill in more detailed expenditure projections. As a user enters an actual expenditure, specific to a budget line item/cost object, a point is annotated on the chart that represents cumulative expenditures taking account of that actual expenditure, and the calendar date of the expenditure. As the expenditures are attributed to the line items/cost objects, new points are plotted and displayed together with the plot of the expectation line. The plotted information indicates to the user the financial state of the project. If a point representing the actual aggregate expenditure is below the expectation line, the project is probably on-track; and if a point is above the expectation line, the project is probably off-track.

The expectation line may be derived by adding projected start and end dates for each budget line item/cost object. Thus, the projected start and end dates of a budget line item/cost object, along with the line item's projected cost, will contribute to the X and Y coordinates of the expectation line that can be used as a gauge of whether a project is on- or off-track (assuming that users input correct expenditure data and allocate this expenditure data to the correct execution data).

### 7. Metadata Capture

The system includes a profile input screen and a backend that allow for metadata capture throughout the music or media creation process. The metadata can be captured automatically. In some cases, metadata can be added manually. The captured metadata can provide members of each project team, and, sometimes additionally, members of a larger community, internal or external to the system, with insight into the creative process of a particular project, session, and/or track. This metadata and the resulting insight may include, but is not limited to, the following:

a. Individual roles/positions held by teammates (e.g., musician, writer, producer, engineer, A&R, academic institution faculty/educator, etc.)

b. Individual instruments played or expertise of teammates

c. Number of projects, sessions, teammates per individual

d. Contribution to a project (e.g., time on site, amount of data uploaded, amount of input on a project/session, tools used during project/session created, comments, revisions, etc.)

e. Geographic location during team interaction

f. Individual compensation figures

g. Project cost, schedule, and performance data (e.g., budget line-items, expenditure amounts, expenditure schedule figures, schedule constraints, task-oriented project/session completion status, etc.)

h. Media (audio files, images, etc.)

These data can be managed/organized in such a way as to provide users of the system detailed insight into the music and media creation processes. Such insight can allow the users to understand how individuals or a project team may be able to change behavior associated with the creation processes in favor of cost, schedule, and/or overall performance savings. A wide variety of applications are possible for this metadata.

### 8. Project Create

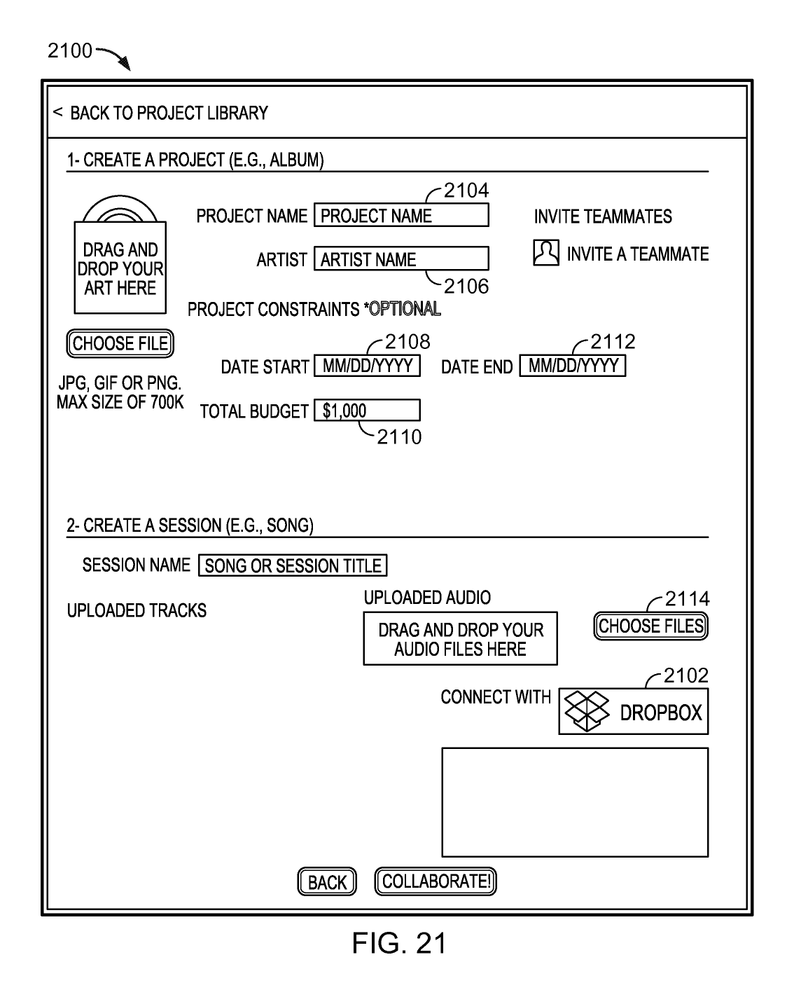

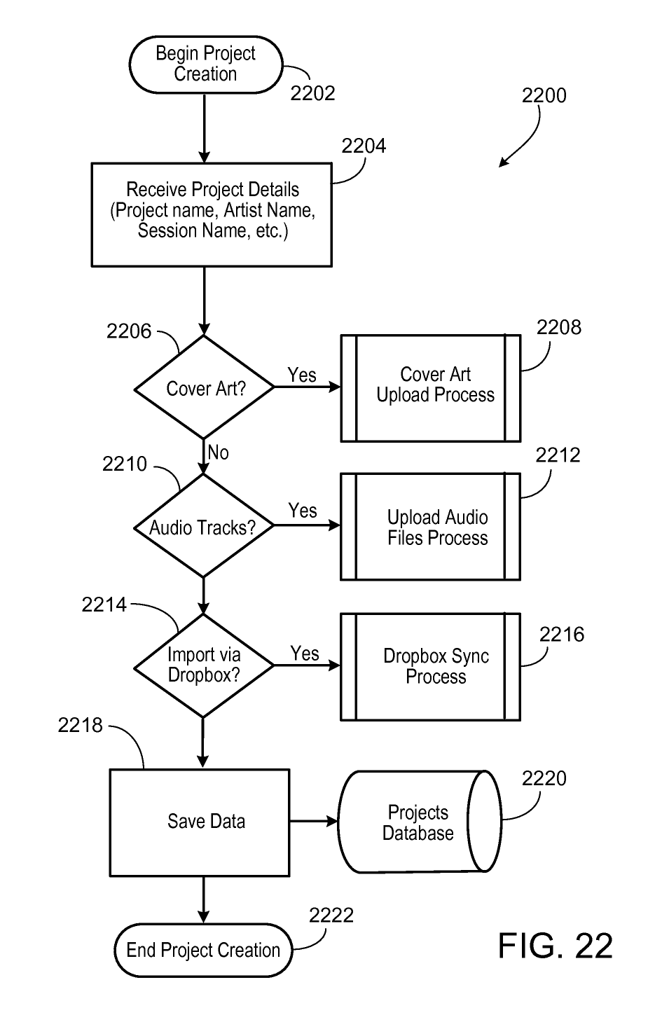

A new project, and optionally a session within that project, can be created by a user through a Project Create screen 2100 shown in FIG. 21. Additionally, from this screen 2100 the user is able to upload audio files and optionally connect to or synchronize with, cloud file storage providers (e.g., Dropbox 2102). The names of the project 2104, artist 2106, and session may be required in order to create necessary records for the project and the session in a database of the system. Project constraints also can be added (project start and end dates 2108, 2112, total budget 2110, etc.). If the project has associated cover-art, this can be uploaded on the screen 2100 as well. This cover art may be used when displaying the list of projects in the project library, and elsewhere on the site or when publicly distributed.

Audio tracks can be added to the project from this screen 2100 using several different features. In one example, a user can drag files from his local computer interface directly into the browser, click the “Choose Files” button 2114 (in which case the client's operating system file selection dialog window will open, allowing the user to select the desired audio files), or utilize the system's Dropbox application (reference the Dropbox Integration section below for details regarding this upload method) or a combination of two or more of these techniques. Once selected or dragged into the browser, the files will be uploaded securely using the Secure Sockets Layer (SSL) to a web server (e.g., web server 302 of FIG. 3) of the system. Once on the server, the files are encrypted and records are created in the database, associating the uploaded files with the project and session being created. If the files being uploaded are in the Broadcast Wave Format (BWF), metadata from these files can be extracted using public domain licensed software. For example, time offset values relevant to the audio file, as it was created in its Digital Audio Workstation (DAW) environment, are extracted and applied to the file as the file is converted to MP3. This is because the BWF file may not start at the beginning of an audio file, but may be inserted at any point in the session. For example, if the file's offset is 1:34, 1 minute and 34 seconds of silence are added to the beginning of the track when it's converted to the MP3 format.

An example of the workflow 2200 during the project creation process is shown in FIG. 22. Project creation can begin (2202) with activating the system to display the screen 2100 of FIG. 21 to a user. The user is prompted to enter project details, such as project name, artist name, session name, etc. The system receives (2204) the input from the user. The user is further prompted to consider whether there is cover art to be uploaded. Based on the user's uploaded information, the system determines (2206) whether there is cover art to be received. If yes, the system processes (2208) the upload of the cover art. If no, as the user is prompted to consider whether there are audio tracks to be updated, the system determines (2210) whether there are audio tracks to be received. If yes, the system processes (2212) the upload of the audio tracks. If no, as the user is prompted to consider whether there are audio tracks to be imported using

Dropbox, the system determines (2214) whether there are audio tracks to be received from importation. If yes, the system synchronizes (2216) the project creation with Dropbox. The system further saves (2218) data input, uploaded, or imported by the user, e.g., at projects database 2220. The initial project creation process then ends (2222).

Other suitable processes can also be used.

I. Dropbox Integration (File View)

Dropbox is a cloud storage service popular among musicians as well as the general public. It is a service provided by Dropbox, Inc. The system of this disclosure allows users to directly copy files from Dropbox to the servers of the system. Although Dropbox is used as an example, other services that offer cloud storage and/or file synchronization can also be integrated with the system.

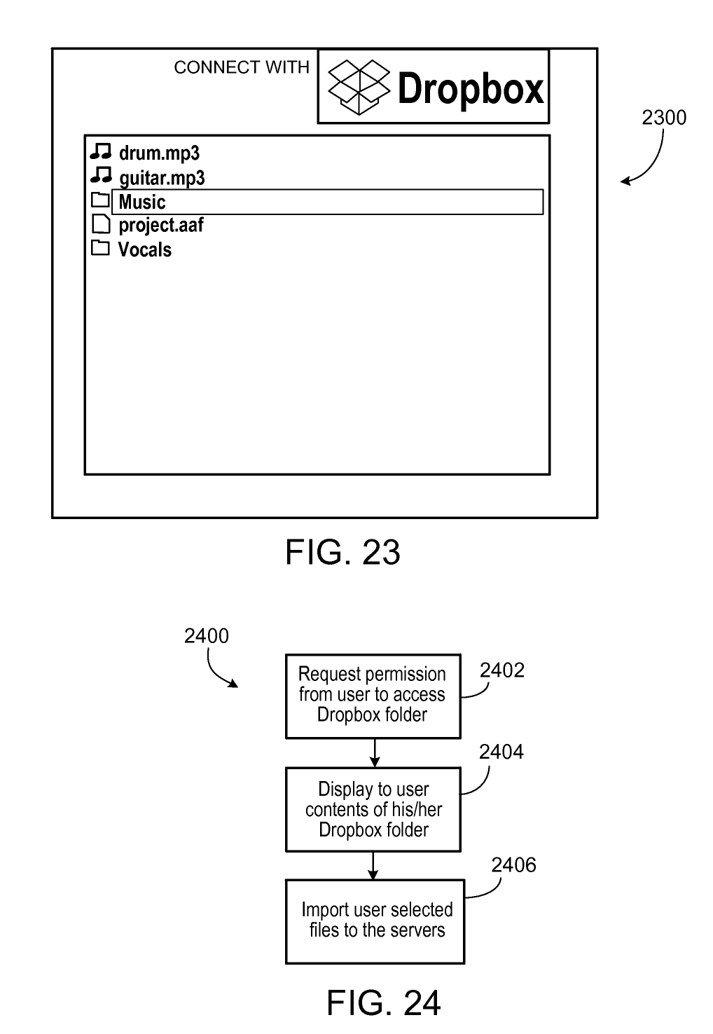

In some implementations, connections from Dropbox to the system are established using OAuth, a standard protocol supported by the Dropbox API. Once a secure connection is established, the system provides a file browser interface to the user's folder, an example of which is shown in FIG. 23.

The interface 2300 of FIG. 23 lists audio files a user can import into a project of the system. Valid audio files are detected by inspecting file extensions and may be labeled with a musical note or other icon. Users can also import an OMF or AAF formatted recording project. This process is explained in detail in the next section.

Changes to a user's Dropbox folder can be automatically synchronized with content on the servers of the system, such that updating selected content of the Dropbox leads to automatic update of related contents on the server. Synchronization is managed by a set of user preferences stored on the servers. An example process 2400 is shown in FIG. 24. The system request (2402) permission from a user to access the user's Dropbox folder. Once user grants the request, in some implementations, the system saves the OAuth access token used to connect to his Dropbox folder. The user may not need to be logged into the system for the synchronization to occur. The system can then display (2404) to the user contents of his Dropbox folder. The system can also import (2406) user selected files to the servers of the system.

### 9. Marketplace

The marketplace (such as the marketplace 104 of FIG. 1) is a part of the team creation/collaboration loop discussed with regard to FIG. 1. The marketplace can have the same features as any marketplace to provide users with the ability to buy and sell items (in this case, music, other media, and media-related services). The marketplace is integrated into the system's team-based project/session construction and, thus, mimics the way team-based business transactions take place within the music and media communities.

Project and session teams are often formed through physical, “real world” connections that are, first, made in an environment outside of the system. For example, two musicians may play music together in the physical space, then meet virtually using the system. In this instance, the relationship was founded in the physical realm. However, through the marketplace of the system, users can build project and session teams without making physical/face-to-face connections. This marketplace makes it easy to grow and expand one's team with value-added teammates, throughout the music and media creation process.

At least primary types of transactions can take place using the marketplace of the system, which are described below, although other types may take place too:
Internal transactions: the buying and selling of services that are internal to one's already-existing project or session team. Within such transactions, a certain level of trust, and a secure connection, has already been formed between key members of a project or session team. For example, a musician invites a sound engineer to one of his project teams. The engineer performs a service for the musician and bills the musician through the marketplace. The musician, in turn, pays for the services performed via the marketplace. The already-existing relationship between these two parties is one of the key features of the marketplace's internal transaction structure.
External transactions: the buying and selling of services that are external to one's already-existing project or session team. In these external transactions, no prior level of trust has been substantiated. For example, a musician is looking for help with “mastering” his newly-recorded audio. He can reach out to the marketplace to find a mastering engineer. After identifying an appropriate candidate, the musician and mastering engineer engage in conversations and solidify the applicable service terms (payment/billing structure, etc.). After these terms have been solidified, the musician may invite the mastering engineer to his team. The mastering engineer performs the negotiated service. The external transactions may also take the form of a request for proposal (RFP)/bidding transaction. For example, a musician releases an RFP to the community of the marketplace, requesting the services of a mastering engineer and highlighting the general terms (e.g., cost, schedule, and performance thresholds, etc.) of the requested business/service transaction. Various mastering engineers within the community bid on the subject RFP. The musician engages in conversation with suitable bidders (discusses finer details of the transaction via the system), and—when appropriate—selects one of the mastering engineers to perform the requested service. The musician may, then, choose to invite the mastering engineer to his project or session team for further engagement within the system.

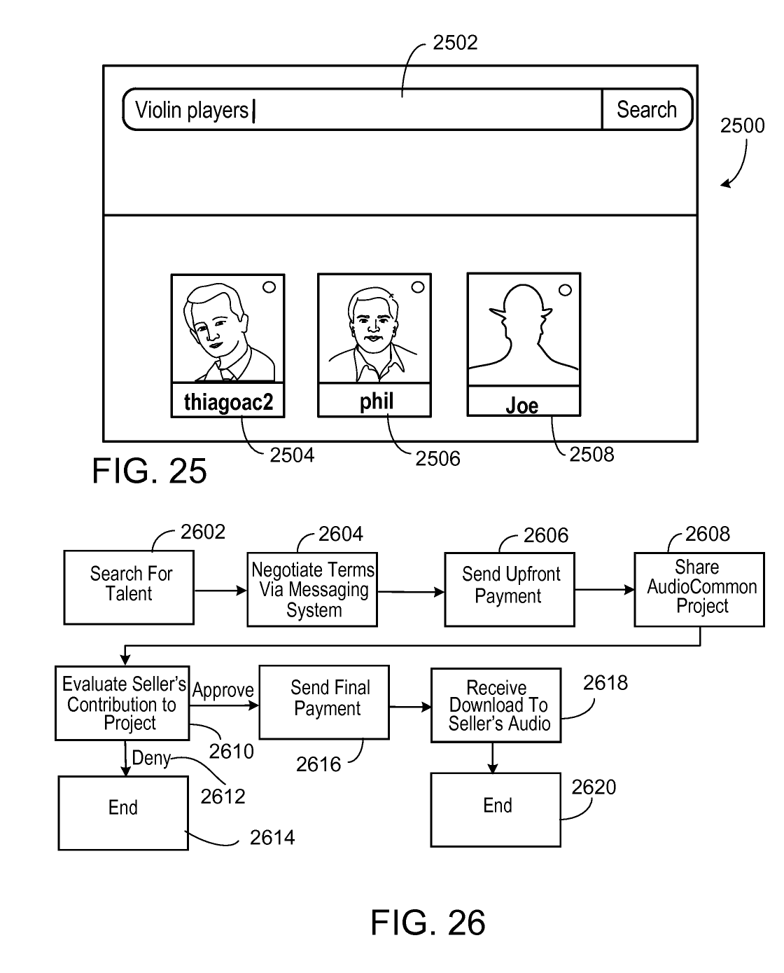

The following example discussed with respect to FIGS. 25 and 26 illustrates the concept of searching for talent that is external to a user's personal network in the system (i.e., to conduct an external transaction). In the example, a user needs a violin part contributed to his project. The user may start the process of finding violin players by searching (2602) for the desired talent. In particular, the user may input a search term, “violin players” in this example, in a search engine 2502 on a user interface or window 2500. Search results 2504, 2506, 2508 showing different violin players registered with the system are displayed to the user.

Once a user has found the desired talent, the user can initiate contact with the talent using the messaging service provided by the system. Other means of communication, such as those based on the information of the talent available to the user, may also be used. The user and the talent then negotiate (2604) terms and begin collaborating on a project. Upfront payment may be sent (2606) by the user to the selected talent. The system can allow a user to send payment to another user account using the payment system provided by, for example, Stripe, Inc. However, any third-party payment API or internal payment system may be used to establish a payment bridge that performs a similar function. To make the actual payment, the buyer visits the seller's system profile and clicks on a link that initiates the monetary transaction. The buyer may then be prompted for credit card information which is sent securely to the applicable servers (e.g., those provided by Stripe, Inc. or others).

The user may then share (2608) his applicable project with the selected talent. After the talent completes his contribution to the project, the system may allow the user to evaluate (2610) the contribution made by the talent (or the seller). If the contribution is evaluated to be unsatisfactory, the user and the system may deny (2612) further payment owed to the talent by the user and the external transaction with the talent ends (2614). If the contribution is satisfactory, the user sends (2616) final payment to the talent. In return, the user may receive (2618) a download of the seller's audio or other media. The transaction then ends (2620).

In some implementations, the system may also be set up as an internal community (e.g., within large music and media enterprises, academic institutions, etc.) with existing cost sharing. In these cases, a secure connection has already been made by establishing the internal system, which connects parties within the enterprise or institution. Thus, users within this internal network can search for prospective teammates in the marketplace of the internal community, and invite people to their project or session teams. For example, a vocalist from a large music institution may be asked to compose a piece of music with a pianist at the same institution. The vocalist searches the internal system for pianist candidates and, after finding an applicable match, he can invite the pianist to his project or session team to collaborate.

The search function provided by the system is a bridge that connects one's internal project structure to the marketplace of the system and allows users to identify potential teammates readily. In some implementations, metadata is captured both during the user profile creation process and throughout the use of the system. The search function of the system can characterize users as having various features to facilitate storing and search for user information. The various features may include one or more of the following items:

a. Individual roles (e.g., musician, writer, producer, engineer, artists and repertoire (A&R), etc.)

b. Instruments played (e.g., guitar, bass, piano, etc.)

c. Associated bands

d. Associated projects

e. Geographic location

f. Expected compensation

The searchable features (or attributes) of the users can be indexed in the system's document-based search engine to provide fast search results. Additionally, incremental search, or “search-as-you-type” features can be used to display search results as the user types, before the user completes entering the entire search term.

### 10. Mobile Implementations

The use of the system can be extended to a mobile environment, which also extends SMMD functionality. In some implementations, the mobile application brings the organizational structure of the system to a user's smart phone or mobile device, and taps into a device's other equipment, such as the microphone and the camera, so that the user can record, organize, and share draft recordings with teammates, and attach photographs to projects and sessions.

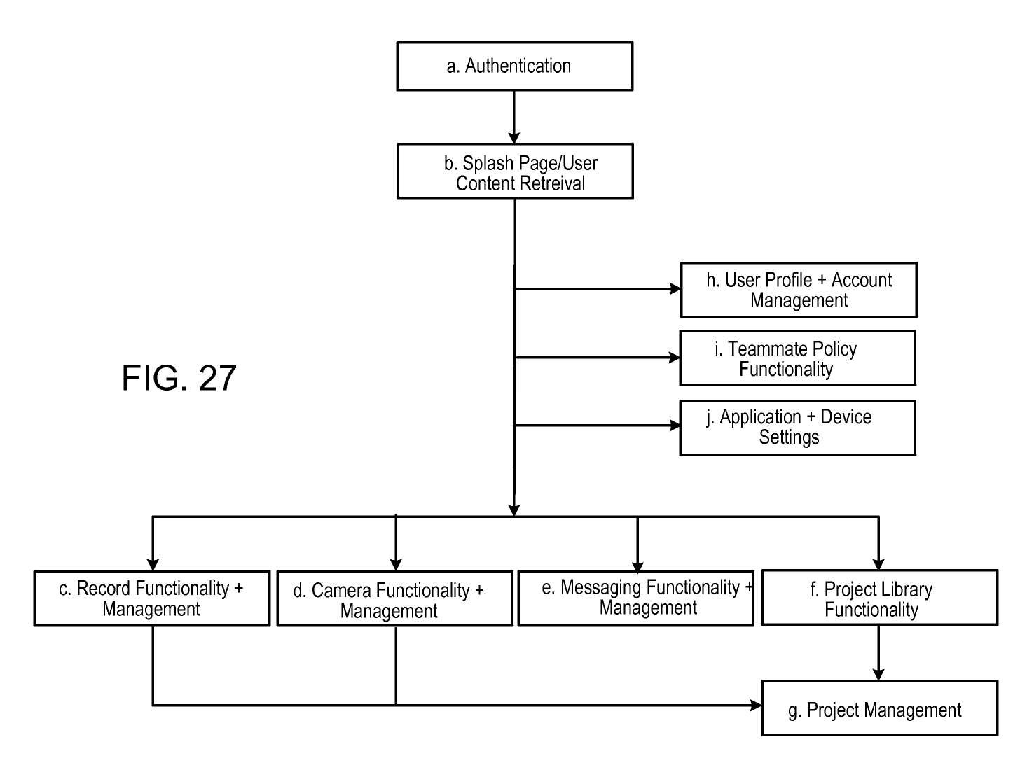

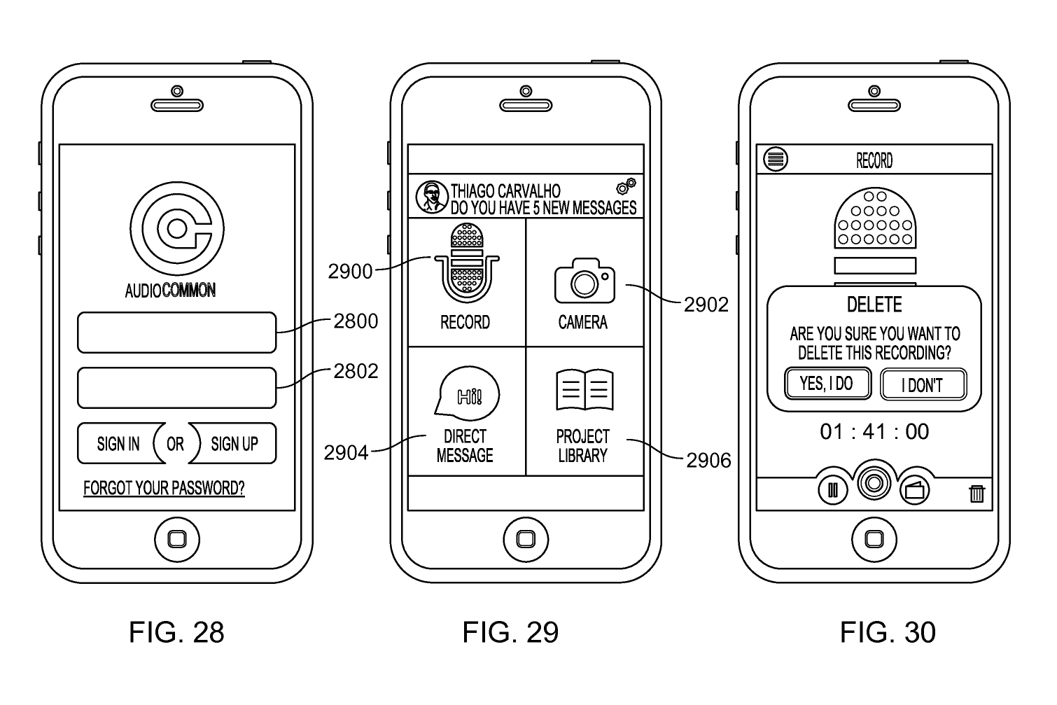

A platform, interface, or application for connecting the mobile device to the system can be installed on the mobile device. Sometimes no installation is required and the mobile device can access the system through a web application, e.g., through the Internet. The exemplary components of the platform or interface presented on the mobile device are shown in FIG. 27. At least some of these components are also reflected in the user interfaces shown on a screen of the mobile device and illustrated in FIGS. 28-36.

a. Authentication: this functionality communicates with the relational database and application server (see, e.g., FIG. 3) through the API of the web server of the system. This component is used to authenticate a user to both the web and the mobile platforms for the purposes of security and user data access. As shown in FIG. 28, authentication may require a user to enter his username 2800 and a password 2802 corresponding to his account at the system. An authentication token is returned to the mobile application which can be used in headers for follow-up requests to the web server of the system using either JSON Objects or XML Posts for user information and data stored on the database.

b. Splash Page/User Content Retrieval: this functionality may use the authentication tokens to request, send, and receive JSON objects/XML posts, which contain the user's data from the platform's database. For example, from this splash “landing” page, the user can access any of the four primary functionalities for the mobile application of the platform (see, FIGS. 27 and 29): (c.) recording 2900, (d.) camera/photo-taking 2902, (e.) messaging 2904, and (f.) project library management 2906. The user us also given visual cues that highlight the number of messages and invitations that are pending, as well as other user-oriented indicators (e.g., online status of a user, etc.).

c. Recording-the workflow of this functionality can include the following: the user can use the native microphone of the mobile device to record audio media that can be optionally replayed, discarded/deleted, segmented or saved to a new or existing project or session of the system. Once the media is recorded the user is prompted with the options, and if he/he chooses to save the media, the media can be saved to a pre-created project or a new project and session. Both the pre-created and the newly created projects/sessions can be used on both the mobile and the web applications. In the example shown in FIG. 30, a user chooses to delete a recording he/he made. The project structure associated with the mobile application is similar to or the same as those described in the web platform. For example, the user can use their mobile device to create and/or change the properties of a project, invite teammates to view the project, etc. The recordings can also be attached to direct messages within the platform and/or be included in any of the system's metadata.

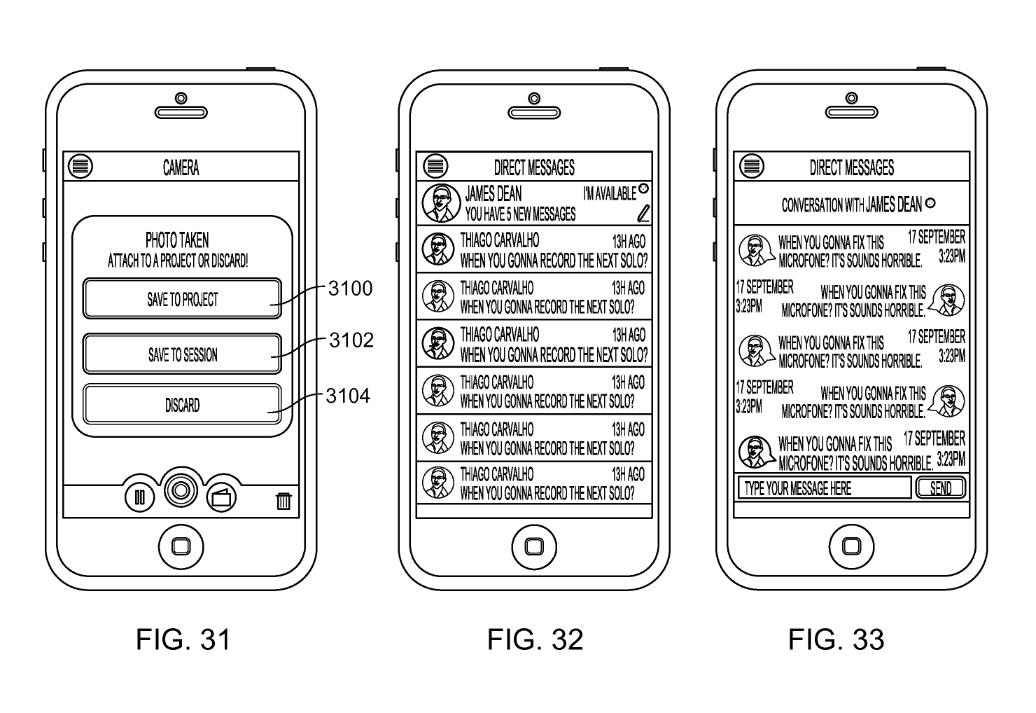

d. Camera/Photo: the workflow of this functionality can include the following: a user can use the native camera of his/his device to capture visual media (e.g., photos, videos, etc.) that can optionally be discarded, or saved to a new or existing project or session of the system. In the example shown in FIG. 31, a user is provided with an option 3100 of saving the recording to a project, an option 3102 of saving the recording to a session, and an option 3104 of discarding the recording. These visual media can be attached and attributed using visual markers within projects/sessions, and/or through the direct messages sent inside and outside of the platform. Additionally the visual media can be attached to or included in any of the system's metadata.

e. Direct Messaging: the workflow of this functionality can include the following: a user can use the messaging feature of the system to draft, send, receive, and review text-based messages through the platform to and/or from teammates or other users of the system with whom the user has already collaborated. In addition, the user can also send and receive messages to those users with whom the user has not collaborated. Sometimes these messages may need to be approved by the system. An example of the direct messaging is shown in FIG. 33. The conversation of two users is published on the screen of the device. Additionally, direct messages can be sent to email addresses. In some situations, the email has to be opened to read the received messages on the platform. The email invitee may receive an invitation to read the message in his email once the message is sent from the system. In the example shown in FIG. 32, a user receives an invitation to read five new messages. In some implementations, the direct messages of the system are text-based. The messages may also have additional data attached, such as photos, audio recordings, and links to projects on the platform.

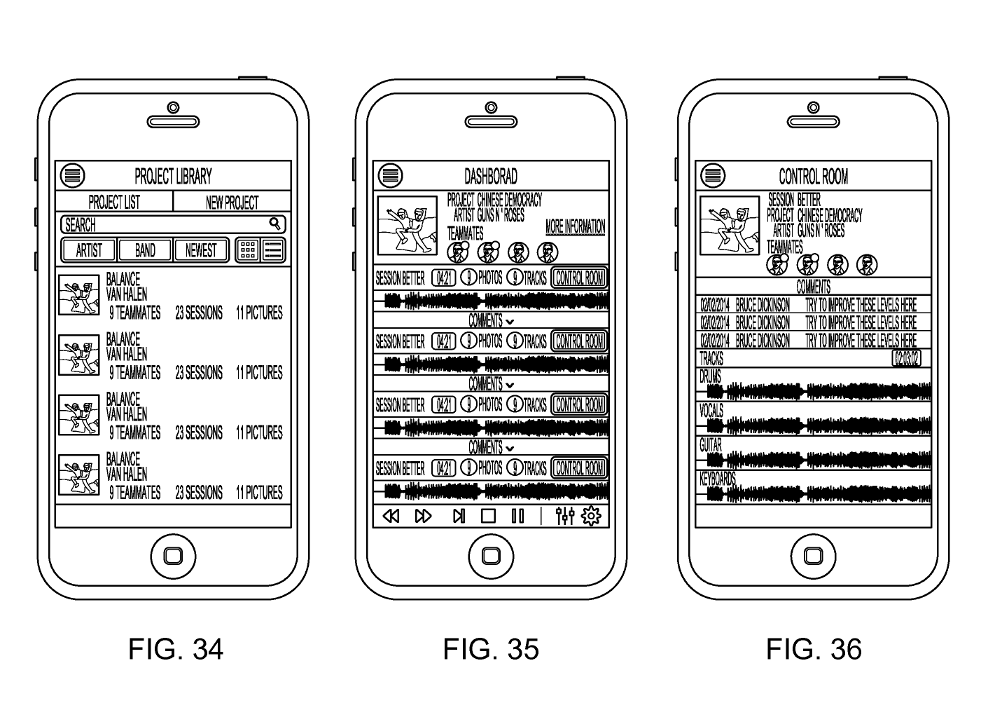

f. Project Library: this workflow can be a mobile device version of the web application's functionality of the project library discussed above and can include the following: providing a user with the ability to 1. View, 2. Create, 3. Edit, and 4. Review projects. 1. The user has a visual representation of selected folders, projects, and/or sessions or all of his current folders, projects, and/or sessions. The user can search, organize, and use the project's visual representation or icon to access project details, such as number of sessions, number of teammates, number of comments, versions, mixes, etc. 2. The user has the ability to create a new project/session in which he can add recordings and photos taken within the mobile application. The user can also invite teammates to this new project. 3. The user has the ability to change the project settings similarly to the web application. 4. The user has the ability to access sessions of his existing projects and to track the sessions/projects using a link to the dashboard and subsequently to the control room of each corresponding session. An example of the project library displayed under the mobile application on a screen is shown in FIG. 34.

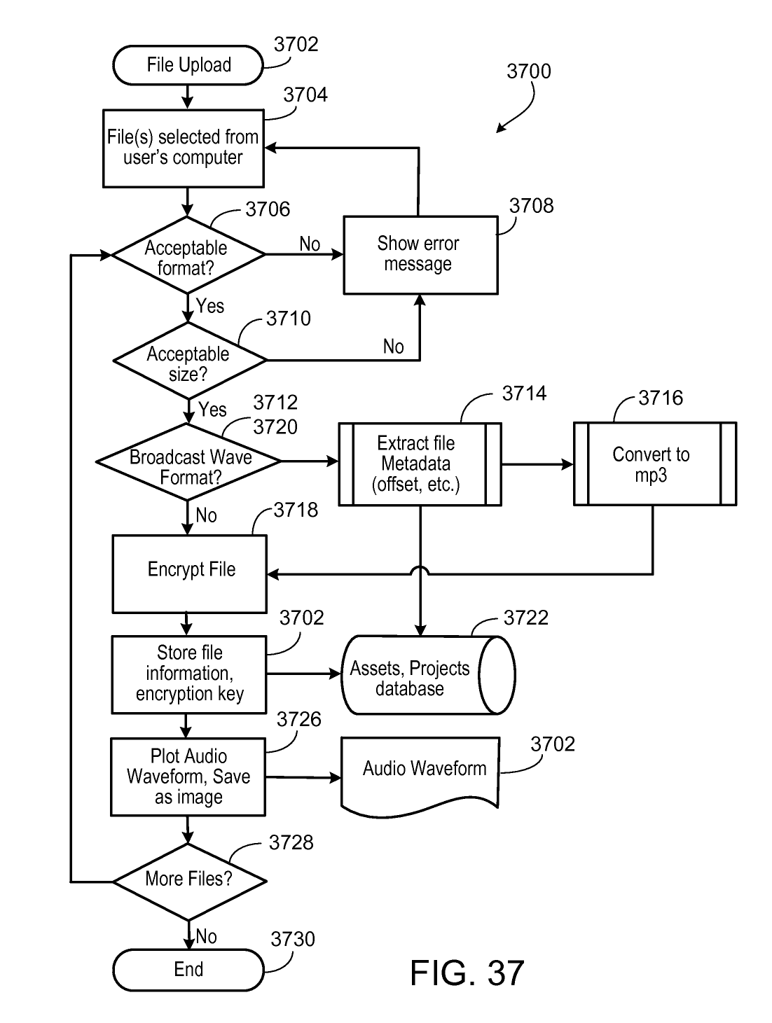

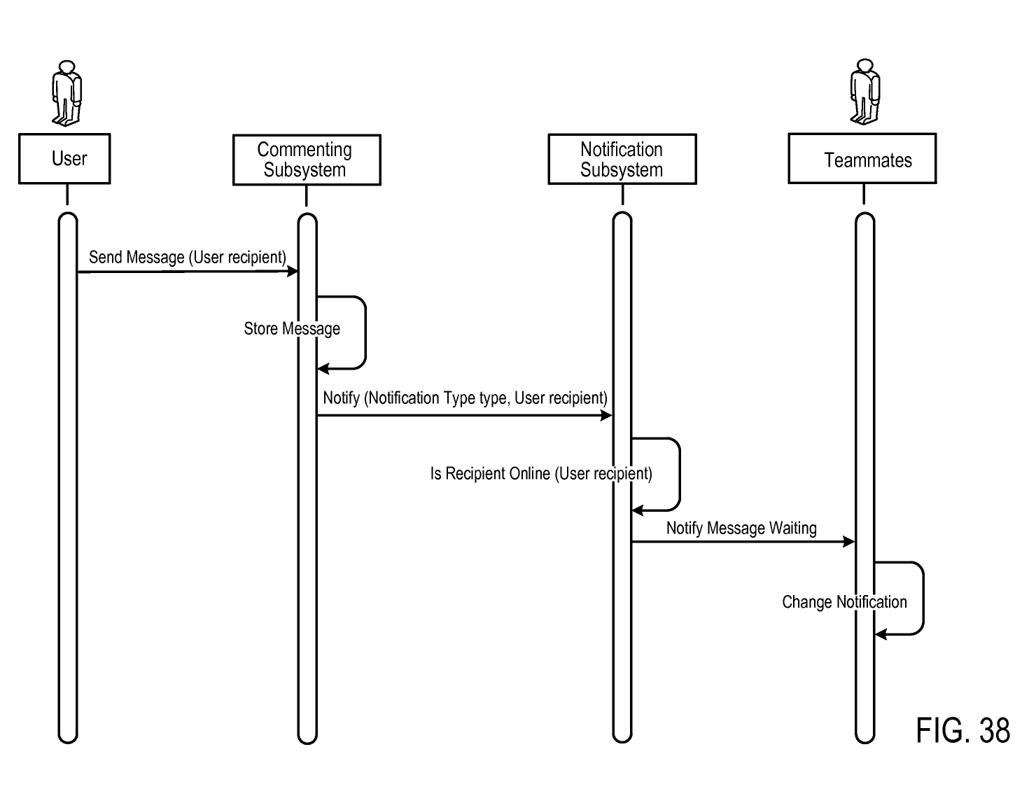

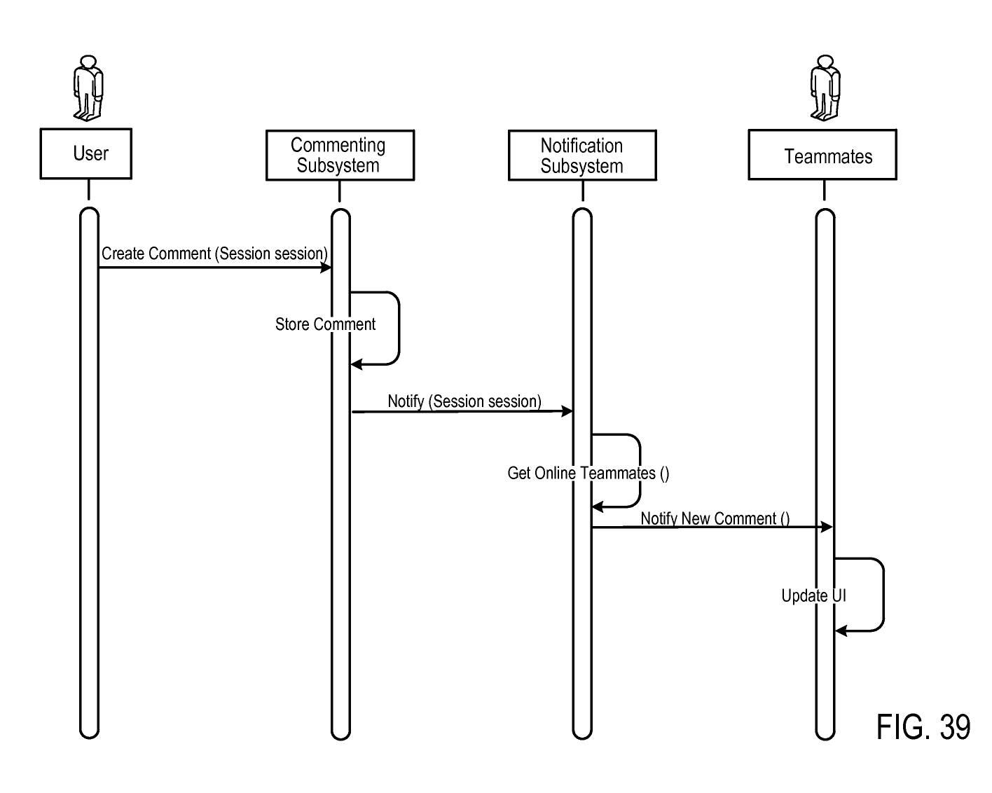

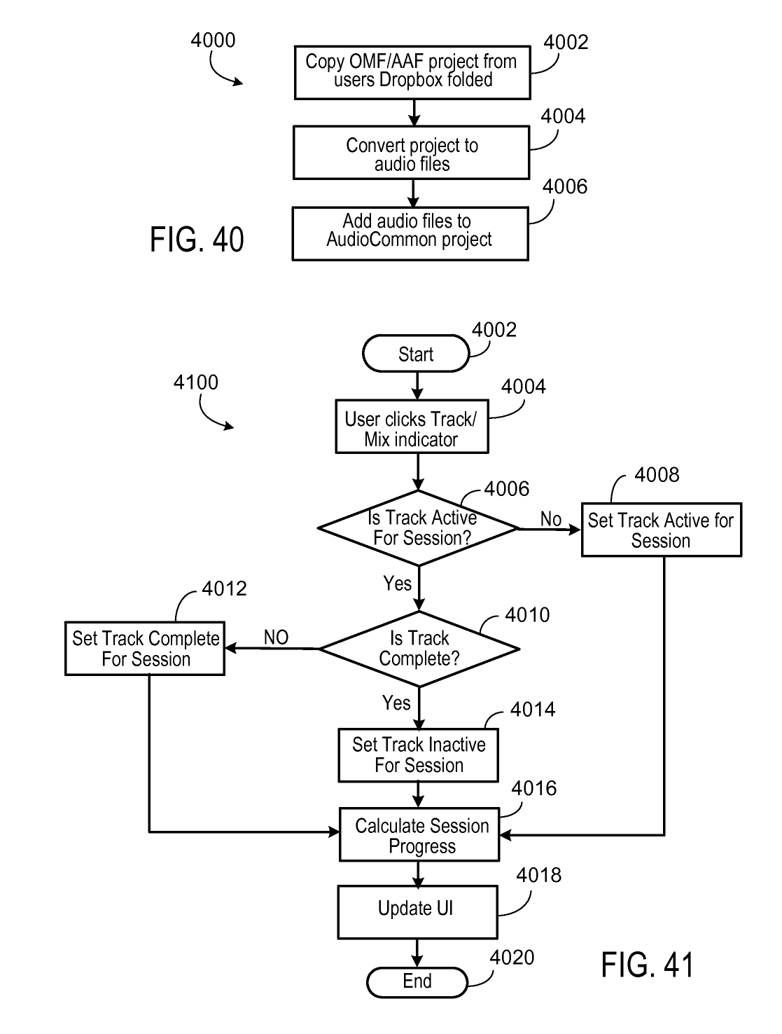

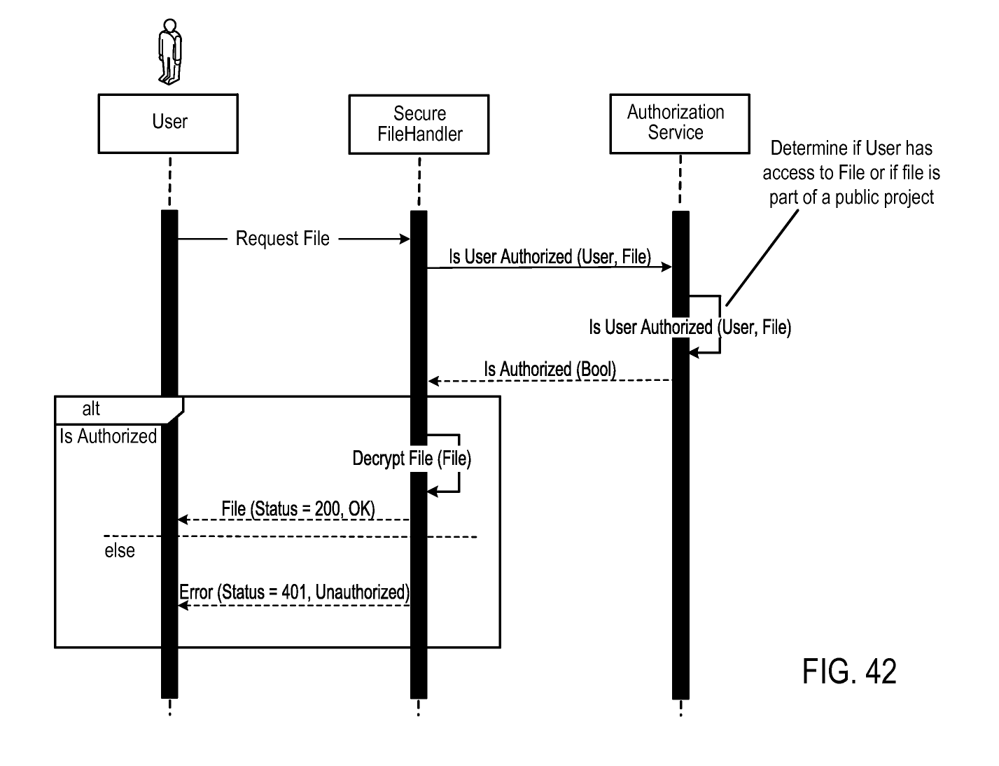

g. Project Management: this references the links from existing projects in a user's project library to the dashboard and control room of those projects. These functionalities are similar to or the same as those of the web application, with the exception that recordings can be added to sessions and projects from the mobile device's native microphone. An example of the dashboard displayed under the mobile application on a screen is shown in FIG. 35, and an example of the control room displayed under the mobile application on a screen is shown in FIG. 36.

h. User Profile and Account Management-: his functionality provides a user with the ability to change both his public profile information and his account information (i.e., username, password, administration privileges/settings, etc.). Such functionality is similar to or the same as those of the web application, with the exception that recordings can be added to sessions and projects from the device's native microphone.

i. Teammate Profile: this functionality allows the user to access the public profile of any of his teammates, e.g., by linking from the photos of the teammates shown in a direct message, by invitation, by project or the project library view, etc. The functionality is similar to or the same as that of the web application.

j. Application and Device Settings: this functionality allows the user to adjust his preferred application settings (i.e., sound, push notifications, dual logins, etc.) with a specific device.

### 11. Other Features

### I. File Upload

FIG. 37 shows a flowchart 3700 illustrating an example of a sequence of events during a file upload process in which one or more files are uploaded from a user's device to the system, e.g., a project or session of the system. The uploading can take place through a web application or through a mobile application. Once the uploading process begins (3702) and one or more files to be uploaded are selected (3704) from a user's device, the system determines (3706) whether the file(s) are in acceptable formats. If not, an error message will be shown (3708) (or delivered) to the user. If yes, the system then determines (3710) whether the file(s) have acceptable sizes. If not, again an error message will be shown (3708). If yes, the system further determines whether the formats are the broadcast wave format. If yes, the system extracts (3714) file metadata and converts (3716) the file(s) into MP3, which is then encrypted (3718). If not, the system encrypts (3718) the file(s). The file information and the encryption key are stored (3720), for example, in a database 3722. Audio waveform 3726 is plotted (3724) based on the received file(s) and the plot is saved (3724) as an image. The system then proceeds to determine (3728) whether there are additional files being uploaded. If yes, the system repeats the steps from the determination step 3706. If no, the system ends (3730) the file uploading process.

### H. Notification Subsystem

a. The notification subsystem enables the system to notify connected users about various states of the system in real-time, including but not limited to, project invitations, direct messages, changes to a session state (e.g., tracks added), additions/deletions/modifications of comments, system downtime notifications, etc. The notification subsystem maintains a persistent connection to the users and passes messages across this connection. Messages can originate from a user, e.g. a direct message, an invitation to a project, or a comment on a track, and are passed from the originator to a server of the system, then back to the appropriate, connected users. Messages can be broadcast back to a single user, a group of users, or all connected clients based on the nature of the message. For example, a direct message originates with one user and is broadcasted to the intended recipient(s) of the message. The system is instructed, based on the initiation or delivery of the message, to update the notification icon of the recipient(s), indicating an unread message is in their inbox. In another example, a new comment on a waveform instructs the system to notify all connected team-members of the associated project or session that a new comment has been added and to update the user's user interface, e.g., by refreshing the list of comments and comment-markers.

b. FIG. 38 is a sequence diagram showing an example of a sequence of events when a message is sent from a user and how the notification subsystem notifies the recipient(s).

c. FIG. 39 shows a sequence diagram showing another example of a sequence of events when a user comments on a track, and how the notification subsystem notifies the user's teammates.

### III. OMF/AAF Format

The open media format (OMF) and the advanced authoring format (AAF) are industry standard computer storage formats for audio recording projects. The system can import OMF/AAF projects from a user, e.g., using an example process 4000 shown in FIG. 40. Initially, a user copies (4002) an OMF-formatted or AAF-formatted project from a Dropbox folder, e.g., using a process described above. The system then converts (4004) the imported project to stand-alone audio files that can be played in a user's web browser. This conversion process can be done on servers using publicly available software libraries. Audio files generated by the conversion process are then added (4006) into a project.

### IV. Multi-Track Playback

Typically when a user listens to media in a web browser, a single audio file is downloaded and played back, either natively in the browser or using a plugin or application on the client's device, such as a computer. When a user is collaborating on multi-track data, multiple audio tracks may need to be played back synchronously to re-create the desired sound.

The system allows for playback of multiple audio files synchronously, which enables the user to mute tracks, solo tracks, and control the overall volume level of a track on a track-by-track basis. Additionally, effects can be applied at the track level as well, enabling the user to enhance or otherwise alter the sound of the track, or portions of the track.

Synchronous playback of multiple audio files is accomplished by associating multiple audio files or tracks with a particular song or session. When a session is selected for playback by the user, the associated tracks for that session are downloaded into the client's web browser. Once enough of the tracks have been downloaded to ensure uninterrupted playback of all tracks, the playback begins. Muting a track changes the volume of that track to zero, while storing the previous volume state so that it can be restored if the track is un-muted. Soloing a track effectively mutes all other, non-soloed tracks.

### V. Waveform Annotation

As explained previously, the system enables or allows for annotation of the audio tracks and sharing these annotations among teammates of a project. These annotations can be time-synchronized to the audio track and provide comments at specific points in a track (sometimes also called a point comment), over a specific range (sometimes also called a range comment), or over the entire track (sometimes also called a track comment). Inputting the annotation can start with a user clicking (by mouse or touch input on a screen) on the waveform representation of an audio track. To determine the start time of the comment (or annotation), the system calculates the relative position of the user click with respect to the audio track. If the user performs a click-and-drag action, the end time of the comment is also calculated based on the point at which the mouse or touch is released. The user is then prompted to enter the comment, after which or during which the user can either save or cancel the input operation. If a comment is saved, the content of the comment, the associated track, the start and end time, and information about the user who made the comment are saved to a database. Additionally, markers can be added to the waveform to indicate the position(s) of the comment(s). For example, for point comments, a semi-transparent triangular marker can be added. For region comments, a rectangular marker can be added over the waveform to indicate the start and end of the comment. Track-wide comments can be indicated by changing the color of an icon at the beginning of the track. In some situations, multiple range comments on the same waveform may overlap in time. The markers of these comments can be stacked without directly overlapping visually, e.g., the vertical positions of the markers are different. Each comment can also be added to a comment list for a session, so that users can easily view all the comments for a particular session, e.g., a song.

### VI. Internal Intermediary XML/OMF Format

Recording projects stored in OMF or AAF can be converted by servers of the system into human readable XML. The OMF/AAF is decomposed into a family of project, track, and wave tags that describe the make-up of the project. An example is shown below:

```
<project> My Song </project>
    <track name = “guitar”>
        <wave>
            <start> 0:30> </start>
            <length> 0:45> </length>
        </wave>
    </track>
    <track name = “vocals”>
        <wave>
            <start> 0:35> </start>
            <length> 0:35> </length>
        </wave>
    </track>
</project>
```

The converted XML allows for easy reconstruction of the audio recording project in many environments. For instance, the XML can be parsed by the servers of the system or in a user's browser. The converted XML can also make searching and storage of the audio recording project easy.

To convert an OMF or an AAF to XML, the system can leverage the AAF software development kit (SDK) made available by the Advanced Media Workflow Association. This SDK provides code for traversing the binary encoded OMF or AAF file. The system can use this code to populate fields in the XML file.

### VII. Sequence Diagrams

In some implementations, the media assets stored in the system are encrypted, e.g., using a 256-bit key or an Advanced Encryption Standard algorithm. The encryption protects the content of the media assets in situations, for example, when the system breaks down. The media assets become useless without the key and initialization vectors (IV) used for the encryption. Sometimes the keys are also encrypted. The files of the media assets are decrypted upon request and after authentication and authorization. A flow diagram showing an example of file decryption and authorization is shown in FIG. 42.

### VIII. Data Model

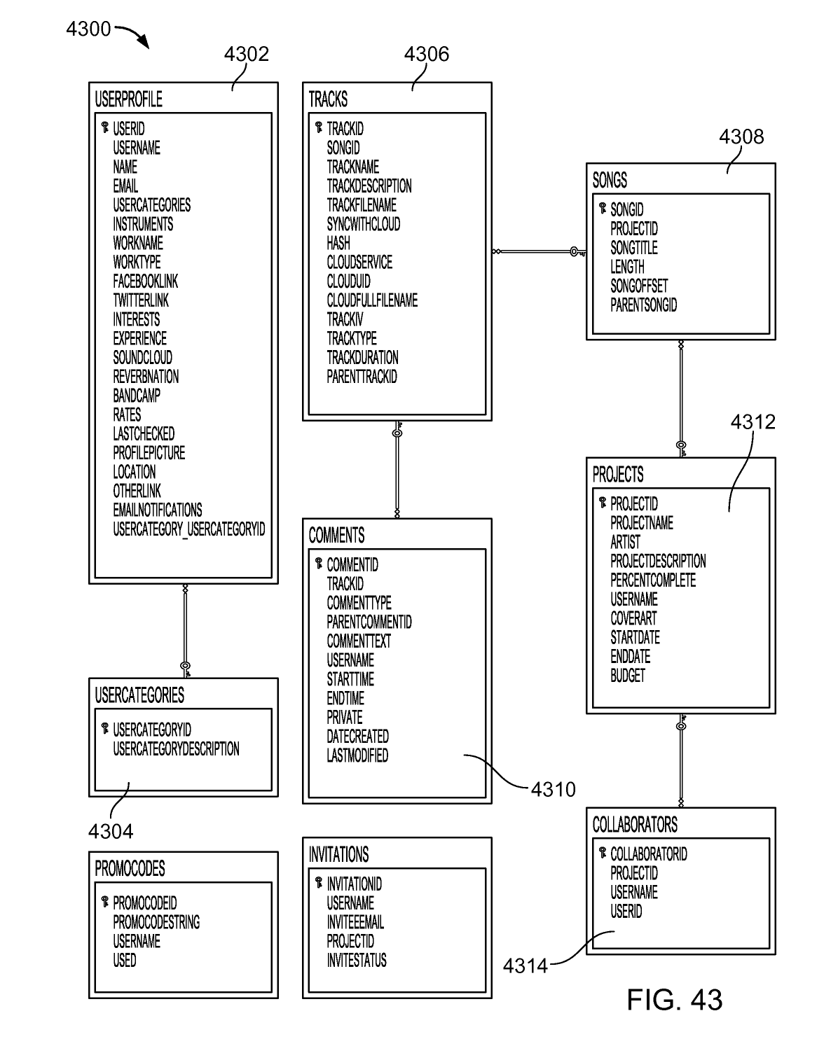

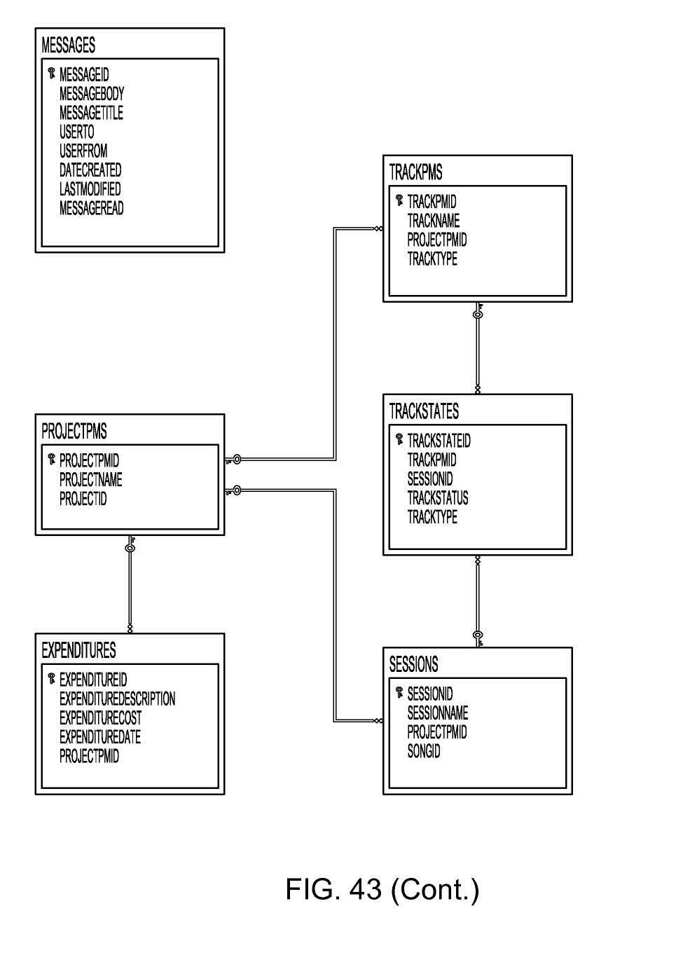

Referring to FIG. 43, an entity-relational model 4300 describing one or more databases of the system or platform of the disclosure shows relationships of different entities in the database(s). For example, data in the database(s) represents user profiles 4302 that have attributes describing the characters of each user of the system. Based on the profiles, the users are categorized and some other data in the database(s) represents categorization 4304. In some examples, some stored data is associated with tracks 4306, which can be associated with other data that is associated with comments 4310 on the tracks 4306 and be associated with songs (or sessions) 4308 as part of the songs. The songs 4308 are related to projects 4312, which in turn, relate to collaborators 4314.

### IX. Examples of Uses

Though this is not an all-inclusive list of possible uses of the system and a wide range of applications is possible, the following text details some example uses of the system:

1) Song Creation. One or more of the steps a-e can be implemented (with or without following the specified sequence):

a. Lead songwriter/musician creates a project shell on the system and invites others, such as a band, to the project;

b. Uploads rough-draft song idea (e.g., a stereo way file);

c. Teammates discuss the song structure and the instrumentation, and provide time-synchronized feedback (e.g., via point, track, and/or session comments), without being limited by the geographic location of each teammate. The discussion and the comments can be part of preparation for rehearsal and/or recording;

d. The project is archived within the system for further team work/iteration. The archived project can stand as a team electronic portfolio artifact;

e. Secure direct messaging functionality used for both formal and informal team communication and coordination.

2) Home Recording. One or more of the steps a-g can be implemented with or without following the sequence:

a. Lead songwriter/musician creates a project shell on the system and invites others, such as a band, to project;

b. Uploads DAW-recorded stems to the system for team feedback (e.g., auditioning, instrumentation, etc.) and/or action (e.g., recording through another person's DAW, if geographically separated);

c. Remote teammate internalizes team discussion, downloads applicable files from the system, and imports files into DAW;

d. Remote teammate records applicable tracks and uploads new tracks to the system;

e. Lead songwriter/musician downloads remotely-recorded tracks and imports into a master DAW session;

f. The project is archived within the system. The archived project can stand as a team electronic portfolio artifact;

g. Secure direct messaging functionality used for both formal and informal team communication and coordination.

3) Studio Recording. Steps used in home recording can be similarly employed in studio recording. Sometimes in studio recording, there is much more thorough discussions pertaining to mixing and overall song “feel” than home recording. One or more of the steps a-f can be implemented with or without following the sequence:

a. Engineer creates a project shell on the system and invites others, including a band, producer(s), management, etc., to the project;

b. Uploads applicable stems to the system for team feedback and/or action;

c. Teammates discuss songs and/or provide time-synchronized feedback (e.g., via point, track, and/or session comments), without being limited by the geographic location of each teammate;

d. Engineer reviews time-synchronized comments and makes applicable edits to mix;

e. Project archived within the system. The archived project can stand as a team electronic portfolio artifact;

f. Secure direct messaging functionality used for both formal and informal team communication and coordination

4) Artists and repertoire (A&R) Management. One or more of the steps a-f can be implemented with or without following the sequence:

a. A&R affiliate creates various project shells on the system and invites others, such as bands, producers, engineers, writers, etc. to respective projects;

b. Team uploads audio content to the project of the system throughout the creative process (both in and out of studio);

c. Teammates discuss song(s) and provide time-synchronized feedback (e.g., via point, track, and session comments) without being limited by the geographical location of each teammate;

d. Production team finishes sessions/project; uploads final versions to the system for full review;

e. After approval, project archived within the system. The archived project can stand as a team electronic portfolio artifact;

f. Secure direct messaging functionality used for both formal and informal team communication and coordination.

5) Publisher Management. One or more of the steps a-g can be implemented with or without following the sequence:

a. Publisher creates a project shell on the system and invites others, such as writer(s), producer(s), and engineer(s), to applicable projects;

b. Team uploads audio content to the project throughout the creative process;

c. Publisher and teammates discuss song(s) and provide time-synchronized feedback (e.g., via point, track, and session comments), without being limited by the geographic location of each teammate;

d. Production team finishes sessions/project; uploads final versions to the system;

e. Publisher invites its clients (e.g., film, television, and video game music coordinators, etc.) to applicable project to review the project;

f. After approval, the project is archived within the system. The archived project can stand as a team electronic portfolio artifact;

g. Secure direct messaging functionality used for both formal and informal team communication and coordination.

6) Broadcast Journalism. One or more of the steps a-g can be implemented with or without following the sequence:

a. Reporter/Journalist creates a project shell on the system and invites other, such as editor(s), producer(s) to the project;

b. Reporter captures field audio in remote location (i.e., the reporter is geographically separated from the editorial and production teams) and uploads the audio to the system;

c. Reporter and editor discuss story and audio via the system by providing time-synchronized feedback to the story/audio, without being limited by the geographic location of each individual.

d. After the editor approves, the reporter engages producer; the producer and reporter discuss story and audio via the system; the producer downloads audio files, creates master session and mix of story/audio;

e. Producer uploads final draft version of story to the system for the editor and the reporter to review;

f. After approval, the project is archived within the system. The archived project can stand as a team electronic portfolio artifact;

g. Secure direct messaging functionality used for both formal and informal team communication and coordination.

7) Mobile Applications

a. Musician as a user of the system
i. Use a microphone of the mobile device to capture audio recording via the application provided by the system;
ii. Upload the recording to a project shell such that a project-specific team is able to see, listen to, and interact with audio file;
iii. Teammates discuss song(s) and provide time-synchronized feedback (e.g., via point, track, and/or session comments) without being limited by the geographic location of each teammate;
iv. Project stands as team electronic portfolio artifact for reference during official recording of song;
v. Use secure direct messaging functionality for both formal and informal team communication and coordination.

b. Sound engineer as a user of the system
i. Use a camera of the mobile device to capture an image of studio equipment settings via the application provided by the system;
ii. Upload the image to a project and/or session as electronic artifact.

c. Reporter/Journalist as a user of the system
i. Capture audio recording using a microphone of a mobile device and via application of the system;
ii. Upload the recording to a project shell so that a project-specific team is able to see, listen to, and interact with the audio file;
iii. Editor and reporter discuss story and audio via the system by providing time-synchronized feedback regardless of each individual's geographic location;
iv. After the editor approves, the reporter engages a producer; the producer and the reporter discuss story and audio via the system; the producer downloads audio files, creates master session and mix of story/audio;
v. Producer uploads final draft version of the story to the system for the editor and the reporter to review;
vi. After approval, the project is archived within the system, and the project may stand as a team electronic portfolio artifact;
vii. Use the secure direct messaging functionality for both formal and informal team communication and coordination.

8) Implementing the system in an academic environment
i. Student creates a project shell on the system and invites other, such as the professor/teacher, to the project;
ii. Student uploads an audio to the project to meet specific school assignment requirements;
iii. Teacher passes along feedback on audio by providing time-synchronized feedback (e.g., via point, track, and session comments);
iv. The project is archived within the system for further student/teacher work, grading or iteration and the archived project may stand as a team electronic portfolio artifact.
v. Secure direct messaging functionality is used for both formal and informal student/teacher communication and coordination.

### X. Speech to Text Integration

In addition to displaying comments, in some implementations, the system can display other time-synchronized data, such as lyrics or, in the case of spoken words, the transcription/text of an audio track. The text can be entered manually by a human. Alternatively, audio tracks (e.g., music/vocal tracks or spoken words) can be converted into text using existing speech-to-text technologies that are integrated with the system. Once the audio tracks are transcribed, a user can edit the transcribed text, e.g., to correct inaccuracies from the transcription process, or otherwise change the text. The text can be displayed in a window, in some situations, synchronized to the playback of the audio tracks similar to karaoke-style systems.

### XI. Text to Speech (Speech Synthesis)

When journalism stories are broadcast, scripts or voice-over narration can be uploaded to the system as project/session artifacts. Additionally, the scripts can automatically be converted into an audio speech track, e.g., using existing speech synthesis technologies. Some example implementations of the conversion include determining the rough timing of a script, or developing a rough draft of a broadcast story.

### XII. Song Analysis

Songs or tracks can be analyzed in the system for acoustic attributes (e.g., tempo, key, time signature, danceability, song sections) using existing audio analysis technologies. The analyzed attributes can be automatically associated to individual songs or tracks and be persistently stored in the system. Some of these attributes can be displayed in a list of song properties (e.g., tempo, key, time signature), while others can be displayed graphically over the song or track waveform (e.g., song sections, bars, etc.). The attributes can be compared as different versions of a given song are created throughout the tracking and mixing processes to help quantify how changes to the song affect the attributes. Additionally, users can compare attributes of a song to attributes of other songs, e.g., songs that are within the same genre, to gain insight into some of the differences between the user's song and other songs of interest.

### XIII. Browser Audio Effect Plugin Architecture

A web audio API can apply filters to audio tracks. These filters can be used to build effects commonly used in audio production, such as chorus, reverb, and parametric equalizers. The system can allow the user to select one or more of these effects to be applied to a selected audio track.

### XIV. Architecting System to Drive Community Innovation and Development on Top of Platform

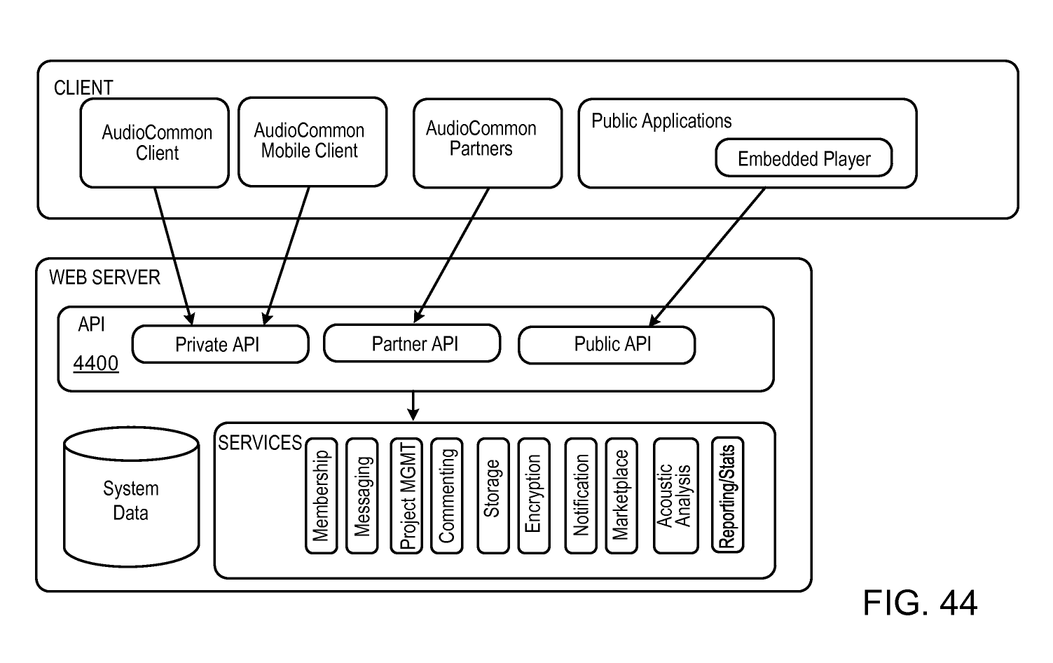

In some implementations, one or more of the functionalities of the system discussed above can be exposed to selected users through an Application Programming Interface (API). The exposure can provide third-party developers with the ability to build applications on top of the system. An example of an API 4400 is shown in FIG. 44.

### XV. Example Computer Systems

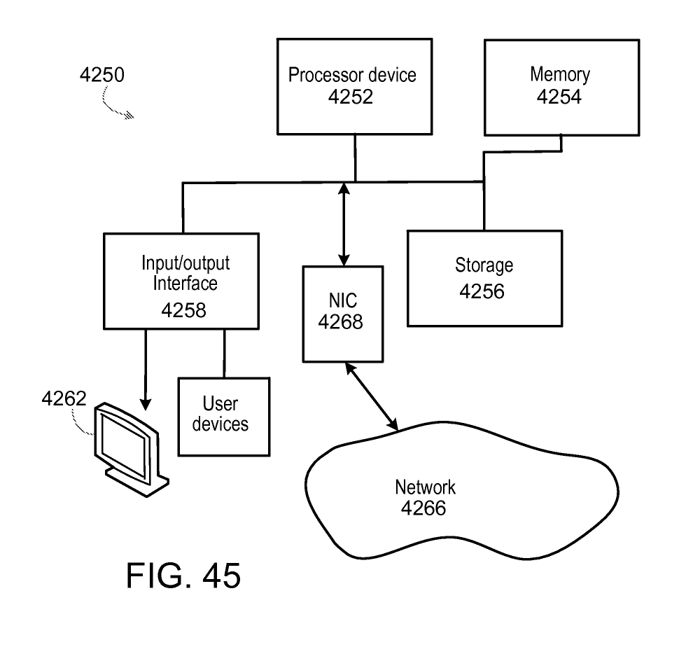

FIG. 45 is a schematic diagram of an example computer system 4250. The system 4250 can be used for practicing operations of the system or the platform described above as well as the client machines through which users of the system access the system. The system 4250 can include a processor device 4252, a memory 4254, a storage device 4256, and input/output interfaces 4358 interconnected via a bus 4260. The processor 4252 is capable of processing instructions within the system 4250. These instructions can implement one or more aspects of the systems, components and techniques described above. In some implementations, the processor 4252 is a single-threaded processor. In other implementations, the processor 4252 is a multi-threaded processor. The processor 4252 can include multiple processing cores and is capable of processing instructions stored in the memory 254 or on the storage device 4254 to display graphical information for a user interface on output monitor device 4262.

The computer system 4250 can be connected to a network 4266, e.g., the Internet, through a network interface controller 4268. Other systems, such as the client machines, can also be connected to the same network or a different network that can communicate with the network.

The memory 4254 is a computer readable medium such as volatile or non-volatile that stores information within the system 4250. The memory 4254 can store processes related to the functionality of the valuation system or valuation platform, for example. The storage device 4256 is capable of providing persistent storage for the system 4250. The storage device 4256 can include a floppy disk device, a hard disk device, an optical disk device, or a tape device, or other suitable persistent storage mediums. The storage device 4256 can store the various databases described above. The input/output device 4258 provides input/output operations for the system 4250. The input/output device 4258 can include a keyboard, a pointing device, and a display unit for displaying graphical user interfaces.

An exemplary view of a computer system is shown in FIG. 45, and is but one example. In general, embodiments of the subject matter and the functional operations described in this disclosure can be implemented in digital electronic circuitry, or in computer software, firmware, or hardware. Embodiments of the subject matter described in this specification can be implemented as one or more computer program products, i.e., one or more modules of computer program instructions encoded on a computer readable medium for execution by, or to control the operation of, data processing apparatus. The computer readable medium is a machine-readable storage device. The features of the disclosure can be embodied in and/or or used with various apparatus, devices, and machines for processing data, including by way of example a programmable processor, a computer, or multiple processors or computers.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment.

Embodiments of the disclosure can be implemented in a computing system that includes a back end component, e.g., as a data server, or that includes a middleware component, e.g., an application server, or that includes a front end component, e.g., a client computer having a graphical user interface or a web browser through which a user can interact with an implementation of the disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and a server are generally remote from each other and typically interact through a communication network. The relationship of client and server arises by virtue of computer programs running on the respective computers and having a client-server relationship to each other.

Control of the various systems described herein, or portions thereof, may be implemented via a computer program product that includes instructions that are stored on one or more non-transitory machine-readable storage media, and that are executable on one or more processing devices. The systems described herein, or portions thereof, may be implemented as an apparatus, method, or electronic system that may include one or more processing devices and memory to store executable instructions to implement control of the stated functions.

Any two more of the foregoing implementations may be used in an appropriate combination. Likewise, individual features of any two more of the foregoing implementations may be used in an appropriate combination. The subsections and their respective titles are used to facilitate reading and understanding of the description. The titles of the subsections do not cover or limit the interpretation of the content of the respective subsections. The content of the subsections are not separate or independent from each other. Instead, any appropriate combinations of features from different subsections can be made.

Elements of different implementations described herein may be combined to form other implementations not specifically set forth above. Elements may be left out of the processes, systems, apparatus, etc., described herein without adversely affecting their operation. Various separate elements may be combined into one or more individual elements to perform the functions described herein.

Other embodiments are within the scope of the following claims.

For example, although much of our discussion has used the example of the creation of original media in the form of multi-track music by a team of contributors, the concepts that we have described are also applicable to other forms of media, such as video, non-music audio, and others.

What is claimed is:

1. A method comprising
enabling contributors to form teams to cooperatively create original media using electronic communication with a server,
enabling the cooperative creation of the original media as a project defined within a user interface accessible to each of the contributors of the team,
enabling the cooperative creation of the original media as the project to occur in working sessions of the contributors defined within the user interface,
enabling the contributors to communicate through the user interface, and
providing security against access by any other party for the original media and the process of cooperatively creating it by each of the teams.

2. The method of claim 1 in which the contributors are geographically separated.

3. The method of claim 1 in which the working sessions occur one after another.

4. The method of claim 1 in which the working sessions occur in parallel.

5. The method of claim 1 comprising
enabling the contributors of the team to communicate by commenting on discrete elements of the original media being created.

6. The method of claim 1 comprising
enabling the contributors of the team to engage in messaging through the user interface.

7. A method comprising
on a workstation or mobile device, presenting a user interface that enables a contributor of a team that is to cooperatively create original media using electronic communication, to become a member of the team,
presenting in the user interface, features that enable the contributor to participate in a defined project associated with the creation of the work,
presenting in the user interface, features that enable the contributed to participate in sessions of the contributors,
presenting in the user interface, features that enable the contributor to communicate with other contributors of the team.

8. A method comprising
on a workstation or mobile device, presenting a user interface that enables a contributor of a team that is to cooperatively create original media using electronic communication and native device media capture, to navigate a hierarchy that organizes information associated with the creation of the original media, the hierarchy including a folder level, project level, a session level below the project level, and a level below the session level that encompasses elements of less than all of the original media, and
controlling access of the contributor to the project and session levels of the hierarchy and to each of the sessions at the session level.

9. A method comprising
maintaining persistently on a server a library of files and data associated with projects for the creation of original media by teams of contributors,
enabling files and data to be added to, removed from, checked out of, or otherwise accessed in the library by authorized contributors of the respective teams,
persistently associating identification information about contributors of each of the teams with their projects,
presenting through a user interface to each of the contributors an active control that enables a user of the interface to link to any of the contributors of the team, and
when a file or data is checked out by an authorized contributor of one of the teams, identification information is included about each of the contributors of the team who is associated with the file or data that is checked out.

10. A method comprising
enabling contributors of a team who are creating original media to communicate with one another by a selected one or more of the following modes of communication
private text communication from one of the contributors to another one of the contributors,
private text communication from one of the contributors to two or more of the other contributors,
public text communication among all contributors of the team who are authorized to participate in communication with respect to a project associated with the creation of the original media, or with respect to a session within the project, and
text or audio comments on the project, the session, or a track of the session.

11. A method comprising
enabling contributors of a team who are creating original audio media to communicate by text or verbal audio comments that are posted through a user interface that is presented to each of the contributors and are stored at a server accessible to all of the contributors,
the contributors being enabled to associate each of the text or verbal comments with an element of the original audio media being created, the element comprising one or more of: a point or region within an audio track of the audio media, an entire audio track, a session of cooperative work on creating the original audio media, and a time synchronized comment as part of a comment for a session.

12. A method comprising
presenting to contributors of a team who are creating original multi-track media a user interface that enables each of the contributors to provide text or audio comments on each of the tracks and to participate in text threads with other contributors, and
enabling a contributor of the team, within a single user interface presentation, to review each of the text or audio comments, read a corresponding text thread, and see an image or avatar representing another contributor who was the source of the text or audio comment.

13. A method comprising
presenting to contributors of a team that is creating original multi-track media, a user interface that enables each of the contributors to cause information of the state of a project to be saved persistently, the state information including solo, mute, and fader of each track of the media, versions of each track, and comments associated with activated versions of the tracks, and
enabling each of the contributors of the team through the user interface to invoke the persistently save state information of the project to cause the user interface to display the project in the corresponding state.

14. A method comprising
enabling contributors of a team that is privately creating original multi-track media, a user interface that enables the contributors to cooperate electronically in the creation of the media through a user interface that represents tracks associated with the media, private communications among contributors of the team, and information about the contributors of the team,
enabling each of the contributors of the team to share at least portions of individual tracks of the audio media in an unfinished state through publicly available social media, without sharing the private communications and without sharing the information about the contributors of the team.

15. A method comprising
incorporating into a file information that conforms to a defined file format and is associated with original multi-track content,
including in the file information representing individual tracks of the audio content,
including in the file information defining a mix-down of the individual tracks,
including in the file metadata associated with the creation of the audio content,
including in the file type information that enables rendering of the metadata as intended.

16. A method comprising
enabling a user of a device that presents publicly available audio-video content to the user to locate and have presented to the user a file of information about tracks that underlie the audio-video content and information associated with the creation of the audio-video content.

17. A method comprising
enabling contributors of a team to create original media cooperatively in sessions that are part of projects, and
accumulating metadata associated with the creation of the original media and that include the identities of contributors to individual parts of the original media, the contributions of the contributors, and costs associated with the creation of the individual parts, and
making the accumulated metadata available for analysis.

18. A method comprising
enabling contributors of a team, who are cooperatively engaged in a project to create original media, to monitor progress on the project by
displaying a project matrix including rows each of which represents a session of the project and columns each of which represents on the session, the columns including details related to tracks of the original media or checklist items.

19. The method of claim 18 comprising
enabling each of the contributors of the team through an online facility to control the content of each of the blocks within the matrix including activating the block, marking the block is complete, or permitting the block to remain inactive.

20. The method of claim 18 comprising
displaying, with respect to each of the rows, an indicator of the progress on the corresponding session based on the status of blocks in the row.

21. A method comprising
enabling contributors of a team, who are cooperatively engaged in a project to create original media, to monitor financial information about the project by
displaying a two dimensional budget graph in which the vertical axis represents budget or cost amounts and the horizontal axis represents a time line, and
enabling any of the contributors to control the information represented on the vertical axis by entering overall budget, budget line item, and cost information and to control the information represented on the horizontal axis by entering at least start and end date constraints.

22. The method of claim 21 comprising
displaying a trajectory line of the budget for the period of the project on the budget graph.

23. The method of claim 22 comprising
at successive times, displaying additional segments of a second actual expenditure line on the budget graph based on an automatic computation from cost information entered by the contributors.

24. The method of claim 21 which the trajectory line is based on an aggregation of projected budgets sub-items.

25. A method comprising
providing an online facility that serves as a marketplace for original media and services associated with original media, the online facility,
the online facility including features that represent the marketplace in terms of projects and sessions associated with the creation of original media.

26. The method of claim 25 comprising
enabling contributors of a team that is creating original media to add members to the team from time to time using the features that represent the marketplace in terms of projects and sessions associated with the creation of the original media.

27. The method of claim 25 in which the marketplace provides a medium to buy and sell the original media and services associated with the original media.

28. The method of claim 27 in which the medium enables contributors of an existing team to buy and sell original media and services among them.

29. The method of claim 27 in which the medium enables contributors of an existing team to buy and sell original media and services from parties who are not part of the existing team.

30. The method of claim 25 in which one of the features of the marketplace comprises a search feature based on one or a combination of two or more of the following characteristics: roles of service providers, instruments played, associated bands, associated projects, geographic location, and expected compensation.

31. A method comprising
enabling contributors of a team who are cooperatively engaged in a project to create original media, to participate in the creation of the original media through apps that run on mobile devices and interact with a server, the participation comprising
enabling each of the contributors of the team to record, organize, and share draft recordings with other contributors of the team, and
enabling each of the contributors of the team to attached photographs to projects and sessions associated with the original media on the server.

32. The method of claim 31 in which the participation comprises
interacting with projects maintained on the server, the interacting including at least one of the following: viewing, creating, editing, and reviewing a project; creating a new project; inviting other people to join the team associated with the project; accessing and interacting with sessions and tracks associated with the project; and managing contributor' s profile on the server.

33. A method comprising
enabling a contributor of a team of contributors who are cooperatively engaged in a project to create original media, to synchronize an audio file of a master digital audio workstation session of the contributor, with the timing of a track of a session that is shared through a server by multiple contributors of the team, the synchronization being enabled by allowing the contributor to enter a start time of the audio file of the contributor's master digital audio workstation session and automatically calibrating a time ruler of a track that is shared through the server to have the entered start time as its origin or starting point.
